(19) United States
(12) Patent Application Publication
(10) Pub. No.: US 2019/0295327 A1
(43) Pub. Date: Sep. 26, 2019

(54) LIFE-IDENTICAL VIRTUAL REALITY BUSINESS PLATFORM MERGED WITH INTERNET OF EVERYTHING, AND OPERATING METHOD THEREFOR

(71) Applicant: PINCOMOBILE, Daegu (KR)

(72) Inventor: Sang Don AN, Seoul (KR)

(73) Assignee: PINCOMOBILE, Daegu (KR)

(21) Appl. No.: 16/464,302

(22) PCT Filed: Apr. 24, 2017
(86) PCT No.: PCT/KR2017/004314

§ 371 Date: May 28, 2019

(30) Foreign Application Priority Data
Dec. 2, 2016 (KR) 10-2016-0163168

(51) Int. Cl. G06T 19/00; G06F 3/01; H04L 29/08; H04L 29/06; G06Q 10/06; G06F 1/16

(52) U.S. Cl. CPC G06T 19/006; G06F 3/011; H04L 67/12; G06F 3/016; G06Q 10/063; G06F 1/163; H04L 63/08

(57) ABSTRACT

The present invention relates to a life-identical virtual reality platform in which actual living environments, people, objects, and the like that are operated by being merged with the Internet of Everything (IoE) are implemented as they are in a space and IoE devices (smart watches, smart bands, IoE sensors, and other IoE devices) that are operated in the space connect and link a virtual world and a real world, so that platforms generated and operated in societies, cultures, various businesses and the like of the real world are configured in the same manner in a virtual reality space as in the real world to allow living the same way as in the real world, thereby, providing convenience services of everyday life.

### TECHNICAL FIELD

The present invention relates to a life-identical virtual reality platform merged with the Internet of Everything, and by allowing everything in an actual real world in which the Internet of Everything (IoE) is operated to be implemented in a virtual reality space, the Internet of Everything (IoE) operated in virtual reality is linked with the Internet of Everything (IoE) in the actual real world and various platforms are configured therein.

The present invention relates to a life-identical virtual reality platform merged with the Internet of Everything, in which, through a user terminal in which a browser is operated, a user and a business, a business and a business, a user and a user, a user/business and an IoE device, and IoE device and an IoE device which are operation subjects (subjects of virtual reality operation and use) of the platforms configured above are such that a virtual reality world in which an actual real world is implemented as it is linked with the actual real world, thereby allowing living the same way as in the real world in the virtual reality world, various platforms are configured therein, and the configured platforms are connected and linked with platforms of the real world, and an operating method thereof.

### BACKGROUND ART

A conventional virtual reality technology has been developed to allow an interaction with five human senses such as sight and touch beyond a three-dimensional space, so that experiencing virtual reality using a virtual reality experience device such as a head mount display (HMD) is possible.

Such conventional virtual reality is not closely related to life, and, thus, has not been popularized but become a limited field used by only some users. In addition, virtual reality to date has a limitation in providing only simple services on a unified platform, and thus, has not been utilized in various fields.

There is a demand for virtual reality which is closely related to life, in which various services are provided through the virtual reality and popularized and everything of an actual life is implemented in an environment in which the actual life is connected with a virtual reality world.

In addition, current virtual reality has a strong image of a fantasy that is far from daily life, and thus, is not supported by the public but used by only some people, and is ignored.

In an effort to overcome such limitations, according to the present invention, in order to implement a real world, in which the Internet of Everything (IoE) is operated, as it is in a virtual world to configure various life-identical platforms therein and allow living daily life in virtual reality, the Internet of Everything (IoE) is merged and operated to link the virtual reality and the actual real world through the Internet of Everything (IoE).

The Internet of Everything defined in the present invention is defined as the ultra-connected Internet in which people, things, sensors, space, ecology, industries, data, systems, and the like are all connected to the Internet such that information is created, collected, shared, and utilized.

In addition, the Internet of Everything (IoE) described in the present invention is an area that also includes the Internet of Things (IoT), and the Internet of Everything (IoE) is an area evolved from the Internet of Things (IoT).

In addition, an IoE device refers to a medium that is capable of sending and receiving information to operate and use the Internet of Everything (IoE) and includes terminals, wearables, smart watches, smart bands, object sensors, systems, and smart learning devices embedded with IoE sensors, which are all capable of information communication.

### DISCLOSURE OF THE INVENTION

### Technical Problem

Conventional virtual reality has tried to configure a variety of platforms to implement the real world as it is to allow living daily life therein and provide various services. However, in the absence of a variety of platforms due to technical factors, the conventional virtual reality has failed to provide services that are popularly used.

As a method for overcoming the above limitation, there is demand for a life-identical virtual reality business platform in which a real life environment in which the Internet of Everything (IoE) is operated is implemented in a virtual space such that an Internet of Everything (IoE) device operated therein configures and operates platforms generated in every industry of the real world by connecting and linking the virtual reality and the real world.

The Internet of Everything (IoE) means the ultra-connected Internet evolved from the Internet of Things (IoT). In general, the connection of all objects and spaces and objects means that information about the properties and activities of the objects is measured and collected. It becomes a so-called super-connected state including reality, virtual and physical world and information world.

The present invention provides and operates a LOVE-browser which enables information derived from the above-mentioned various and vast IoE objects to be operated and utilized in virtual reality and enables a business platform that is optimized and executed for an application use of a user using a life-identical virtual reality business platform to be connected and linked with the real world, thereby providing the life-identical virtual reality business platform the same as the actual reality via a user terminal.

In addition, in order to provide life-identical virtual reality in which an actual real world and a virtual reality world are connected and linked by performing information communication between the Internet of Everything (IoE) devices operated in the actual real world and the Internet of Everything (IoE) devices implemented and operated in the virtual reality to communicate by interaction with objects present everywhere regardless of the difference between objects, environment, systems, people, and cultures, the present invention provides an information communication medium and a LOVE-browser operated on an user terminal.

In addition, the present invention configures a variety of platforms throughout daily life such as industries, societies, cultures, economies, and the like taking place in a real world in a virtual reality world which is merged with the Internet of Everything (IoE) to use and operate all the platforms in the actual real world, thereby providing various services in virtual reality.

### Technical Solution

A life-identical virtual reality business platform merged with the Internet of Everything (IoE), the platform according to the present invention, and an operating method thereof includes a user terminal in which operating systems are operated, the operating systems of smart phones, PCs/tablet PCs, 3D/4D devices, smart TVs, IoE devices (wearables, smart watches, smart bands, IoE sensors, etc.), financial transaction systems, and the IoE, which are a variety of information communication means for operating, using, and experiencing life-identical virtual reality in which the Internet of Everything (IoE) is operated,

a LOVE-browser which integrates and operates information of the user terminal to support a multi-channel operation, scans a user and a spatial image to operate scan information so as to connect and link an actual real world with virtual reality, and implements 4D (feel, touch, emotions, etc.) via various wearables to serve as a medium between the real world and the virtual reality, a real-time interactive virtual reality server which provides and manages in real time data to be interacted with information of the LOVE-browser in the life-identical virtual reality, a VR-AS, a virtual reality algorithm synthesizer which analyzes and classifies information of a virtual reality server by the real-time interaction, and merges an algorithm of data derived from an IoE device and a virtual reality operational data (user data, spatial image data, payment information data, business information, etc.) algorithm to synthesize algorithms in order to generate various algorithm areas to be utilized in a life-identical virtual reality business platform (Live-BP),

an IOE-LDRT which implements 4D (five senses such as sense and touch) via various wearable devices in a biometric bio-algorithm generated in the VR-AS and related to a person and an IoE algorithm (algorithms such as spaces, environments, and things constituting virtual reality) that needs to react with the biometric bio-algorithm by interaction; a VROM, a virtual reality optimization management which configures and manages a virtual reality environment and a business platform that are optimized for operating the life-identical virtual reality business platform based on algorithms transmitted from the IOE-LDRT and the VR-AS,

a Live-BPPM, a module for executing platform information optimized in the VROM on the life-identical virtual reality business platform (Live-BP), a business library in which communication between actual reality and virtual reality is achieved by transmitting information to the LOVE-browser for real-time information communication between a user and a business entity, an IoE object and the like according to the use and operation of all platforms by the user via a user terminal anytime and anywhere in an environment in which the IoE is merged due to the execution of the Live-BPPM, the platforms taking place in the Live-BP which is a life-identical virtual reality business platform in which virtual reality is connected and linked to an actual real world, and thus, is the same as the daily life in the real world,

a virtual reality financial platform VRFP, as a component of the Live-BP, which processes and operates finance-related platform information in real time, and a PIM, a platform insight management which inspects platform information operated in the Live-BP to transmit the same to the real-time interactive virtual reality server, thereby providing the same to a user and a platform operator.

In the present invention, the LOVE-browser, a virtual reality browser having a scan function and an IoE operating system function merged therein includes an MCOS-Scanu, a multi-channel operating system in which various information communication media and IoE data derived from an IoE device are compatibly operated, thereby allowing various virtual reality channels to be freely used to operate and use the life-identical virtual reality business platform (Live-BP), and which is capable of performing 3D (three-dimensional) scanning and operating an environment constituting a user and virtual reality by having a browser merged with a scan function, an AST, a three-dimensional scanning tool which enables, among components of the MCOS-SCanu, a browser to implement a 3D scan function, thereby allowing the browser and the scan function to be merged in an environment in which the IoE is merged,

a 4D device that uses the Live-BP among the components of the MCOS-SCanu, and connects and links an actual real world via every wearable, thereby, when using the Live-BP, providing the same feel as that of a spatial environment and the like in which an actual real space is implemented as it is, an ICH which classifies the virtual reality multi-channel information according to the structure and characteristics of data, an IoE incubator which manages only IoE-related derived from an IoE device introduced from the ICH, an IoE-SB, a virtual reality IoE security system which checks for vulnerabilities and prevents security incidents, thereby preventing any errors or failures from occurring due to the IoE data introduced above,

a VR-incubator which loads and manages the virtual reality operational data introduced from the ICH to stabilize complex and a large amount of data, and maintains the safety of the data such that the virtual reality operational data is smoothly operated, a VR-ISB, a security management system which ensures the security and safety of the virtual reality operational data introduced above,

a DCLE, a data compatible device for integrating and compatibly linking data introduced from the IoE incubator and the VR-incubator, which interconverts and links the IoE data and the virtual reality operational data such that the IoE data and the virtual reality operational data are smoothly operated without collision between the data, a VR-DP, which is a data division program for dividing, according to an operation area, the data introduced above so as to operate the life-identical virtual reality business platform,

a scan scope which standardizes and manages scan data as areas of the user scan data and the spatial image data divided above, an user scope which standardizes and manages data an area of the user (business entity) data classified in the VR-DP, a VR-Space scope which standardizes and manages data as areas of the spatial image data constituting a virtual reality space and the data derived from an IoE device among the data classified in the VP-DP, and

a RSC which merges and interconverts the data transmitted from the scan scope, the user scope, and the VR-Space scope, thereby automatically connecting the virtual reality operational data and the IoE device-derived data to a real-time interactive virtual reality server regardless of device, operating system, or program.

In the present invention, the real-time interaction VR server includes a real-time engine which provides feedback to the RSC in real time to deliver a large amount of data introduced from the RSC to a real-time interactive virtual reality data processing engine for operating the life-identical virtual reality business platform in which real-time interaction takes place and deliver the platform insight data introduced from the real-time reporting to the user terminal,

a Real-time Reporting which sends data introduced from the PCM, a component of the PIM which inspects and manages platform information derived from the life-identical virtual reality business platform, to the real-time engine to perform immediate visualization such that business entities using platforms operated in the life-identical virtual reality business platform give real-time feedback and collect and inspect business information,

an IoE Data Furnish Load which loads and manages only the IoE-derived data transmitted from the Real-time Engine to provide data required for operating the life-identical virtual reality business platform, a VR-General Data Furnish Load which loads and manages data related to the virtual reality operational data transmitted from the Real-time Engine to provide data necessary for the life-identical virtual reality business platform in real time, and

a DEMM which integrates and expands data introduced from the VR-general Data Furnish Load and the IoE Data Furnish Load, standardizes the data to be suitable in performing the modeling of data for the smooth merge of algorithms to integrate algorithms of IoE device data and virtual reality general data, and stabilizes a large amount of data.

In the present invention, the VR-AS includes an ADT which classifies data algorithms introduced from the DEMM into IoE-related algorithms (IoE objects such as IoE devices, IoE sensors and IoE operating systems) and virtual reality algorithms (spatial images, users(business entities), every business environment, payment information, etc.) to divide and process the algorithms,

in order to optimize divided and processed algorithms introduced from the ADT for the utilization of the life-identical virtual reality business platform, an AOP which classifies the algorithms into 8 algorithm areas to generate and synthesize algorithms, thereby performing optimization processing, and generates a BAC to process algorithm optimization, and

since every algorithm processed with algorithm optimization in the AOP becomes a source for constituting the life-identical virtual reality business platform, an OAL, an optimization algorithm linkage which supports the algorithms to be compatibly linked with an IoE-LDRT that enables touch of things, feel and emotions of people to be implemented.

The present invention is characterized in including an IOE-LDRT which implements a state and a situational change for a person's emotions and feelings in algorithms introduced from the OAL to implement touch, feeling, a person's emotions generated by a third algorithm related to a user algorithm by interaction according to the change of state in an actual real world in ultra-real time, and transmits to a user via various wearables.

In the present invention, the virtual reality optimization management VROM includes a VR-USD which is classified into 6 algorithm configuration areas so as to implement various business platforms of the life-identical virtual reality business platform based on the algorithms introduced from the IoE-LDRT and the OAL, a VR-BPC which is a virtual reality business platform configuration step of configuring a platform to allow a platform to be freely configured according the configuration of a platform according to six algorithm configuration areas introduced from the VR-USD and the application purpose of a user.

a Live-Bio which configures a life-identical virtual reality business platform environment for creating and setting an environment in which various platforms configured in the VR-BPC are optimized to match a business utilization purpose and use, integrates operating systems, uses, IoE objects and the like which are operated in the platform, and interconverts such that the integrated environment is utilized in a virtual reality business and in an actual world, and a VR-archive, which loads and manages virtual reality platforms configured in the VR-BPC and virtual reality meta-data to extract and supply platform information according to the demand of a user when data is needed.

The present invention is characterized in including a Live-BPPM, a virtual reality business platform execution module which supports such that the platform environment optimized in the Live-Bio is executed in the life-identical virtual reality business platform, and in which various heterogeneous systems such as IoE devices and IoE sensors operated in various platforms are compatible with a platform operated in an actual world, thereby executing a business.

In the present invention, the VRFP (Virtual Reality Finance Platform) includes an FPSC in which finance-related information derived from the life-identical virtual reality business platform is introduced, thereby securing the security of financial information and the safety of financial data, based on financial information verified for security and then introduced from the FPSG, an FIDS which stores and manages the overall financial industry information operated in the Live-BP to classify the information according to the type of financial business, and supply the classified information to a CFC and a Financial Life Cycle Connector, a CFC, a customer financial channel which classifies information introduced from the FIDB into business types according to financial products and types used by users, and in which financial business processing for each financial type channel takes place,

a CFTS, a customer financial processing service, in which a processing service for each financial type according to a user is separately executed based on information introduced from the CFC, a Financial Life Cycle Connector which is capable of, based on information introduced from the FIDB, compatibly linking financial products and services of actual real world financial transactions or Fin-Tech services used in existing real world to be utilized in the Live-BP,

a VR-Document External which manages documents by allowing a document system taking place in a real world to be compatibly linked with electronic document and electronic payment system information introduced from the FIDB to support the document in virtual reality, thereby issuing the document in the real world and in the Live-BP simultaneously, and managing, writing, and viewing external documents,

a VR-security token which is a security authentication token for authorizing data introduced from the CFTS and the Financial Life Cycle Connector, and a FAM, a financial transaction execution module which integrates the VR-security token and information introduced from the VR-Document External and links and manages the integration with the LOVE-browser such that financial transactions taking place in the Live-BP are executed in an actual real world.

In the present invention, the PIM (a platform insight management) includes a BPM which inspects, manages, and analyzes various platforms taking place in the Live-BP, and in order to provide business information to users and business entities, classifies according to the type and management of information, as a method for analyzing the business ecosystem by the BBM and analyzing business sentiment data extracted between a user and a business in the ecosystem analysis and an ecological form in the correlation between a business and a business, a BEA, a Business Ecosystem analysis, which is capable of analyzing the relation between sentiments and ecology when executing a business,

a BEA, a business execution analysis which analyzes and manages data classified and introduced by the BPM for executing a business in the Live-BP and in an actual real world to manage a business life cycle, and supports individual technologies and methods for solving business issues derived from various platforms, and

a PCM, a business information delivery module which delivers data introduced from the BEA and the BPA to business entities and users and achieves an organic connection for guidelines on the operation of a business platform, and serves as a medium for executing the same platform in an actual real world as the life-identical virtual reality business platform.

### Advantageous Effects

The present invention executes a life-identical business platform which implements a living environment of actual reality in which the Internet of Everything (IoE) is operated exactly the same in a virtual space, and connects and links IoE devices and information communication terminals operated therein to a virtual reality world and a real world to configure platforms generated in every industry of the real world the same way in a virtual reality space so as to be operated and used therein.

An actual real spatial background in which the IoE is merged and operated and a real person who uses the IoE are simultaneously implemented to use various platforms configured in a life-identical virtual reality business platform which allows to have the same life as in an actual life, and business entities (uses, business, IoE devices, IoE sensors, etc.) interact with each other to connect and compatibly link not only businesses but IoE devices, IoE sensors, wearables and the like which are operated in the platform configured in the virtual reality, thereby managing and using the IoE in virtual reality and real life simultaneously.

IoE information generated in an environment of the life-identical virtual reality business platform executed above communicates information, via a user terminal in which a LOVE-browser is operated, with IoE devices (IoE sensors, wearables, etc.) of an actual real world such that when the IoE devices are used in the life-identical virtual reality business platform (Live-BP), the IoE devices are connected and linked in an actual real life to be used.

With IoE devices (IoE sensors, wearables, etc.) operated in the actual real world, information communication is performed with IoE devices (IoE sensors, wearables, etc.) implemented and operated in the life-identical virtual reality business platform (Live-BP), thereby communicating with IoE devices present anywhere regardless of space, environment, people, and culture, so that various services throughout the industry such as society, culture, economy, and the like to which every platform of the actual real world is applied may be provided in the life-identical virtual reality business platform.

In addition, a user may use a platform in the life-identical virtual reality business platform (Live-BP) via a user terminal, and platform entities may share through information communication by interaction. In the above, through wearables (smart watches, smart bands, IoE sensor devices attached to human bodies, etc.) used by the user, 4D (senses, feel, emotions, etc.) of environmental factors, people, and the like operated in the Live-BP may be implemented.

Due to voluntary participation by the public in the life-identical virtual reality business platform, it is possible to generate various platforms and supports the distribution of the platforms such that various business models operated in the generated platforms are smoothly operated, and by collecting and analyzing morphological and operational data of businesses operated above, it is possible to inspect and manage platforms operated in the Live-BP and a real world.

It is possible to connect and link financial services operated in the actual real world with various business platforms operated in the life-identical virtual reality business platform (Live-BP), and in the connected and linked environment, it is possible to simultaneously link the Live-BP and the actual real world through the LOVE-browser, so that financial transactions may be done anytime, anywhere.

By connecting and operating virtual reality and a financial system of a real world, business models are diversified, and by accurately identifying financial consumers' needs, appropriate financial services are supplied and operated, and thus, in an environment in which the IoE is merged, a new financial ecosystem connecting and linking virtual reality and a real world is formed. As a result, it is possible to conduct financial affairs of the actual real world through various financial platforms implemented in Live-BP.

### BRIEF DESCRIPTION OF THE DRAWINGS

FIG. 1 is a view showing the overall configuration of a life-identical virtual reality business platform operation according to an embodiment of the present invention.

FIG. 2 is a view showing the configuration of a LOVE-browser according to an embodiment of the present invention.

FIG. 3 is a view showing the configuration of Real-time Interaction VR server (a real-time interactive virtual reality server) according to an embodiment of the inventive concept.

FIG. 4 is a view showing the configuration of VR-AS (Virtual Reality Algorithm Synthesizer) according to an embodiment of the inventive concept.

FIG. 5 is a view showing the configuration of VROM (virtual reality optimization management) according to an embodiment of the present invention.

FIG. 6 is a view showing the area of a life-identical virtual reality business platform (Live-BP) and the configuration of PIM (a platform insight management) according to an embodiment of the present invention.

FIG. 7 is a view showing the configuration of VRFP (a virtual reality financial platform) which is a component of the life-identical virtual reality business platform (Live-BP) according to an embodiment of the present invention.

### MODE FOR CARRYING OUT THE INVENTION

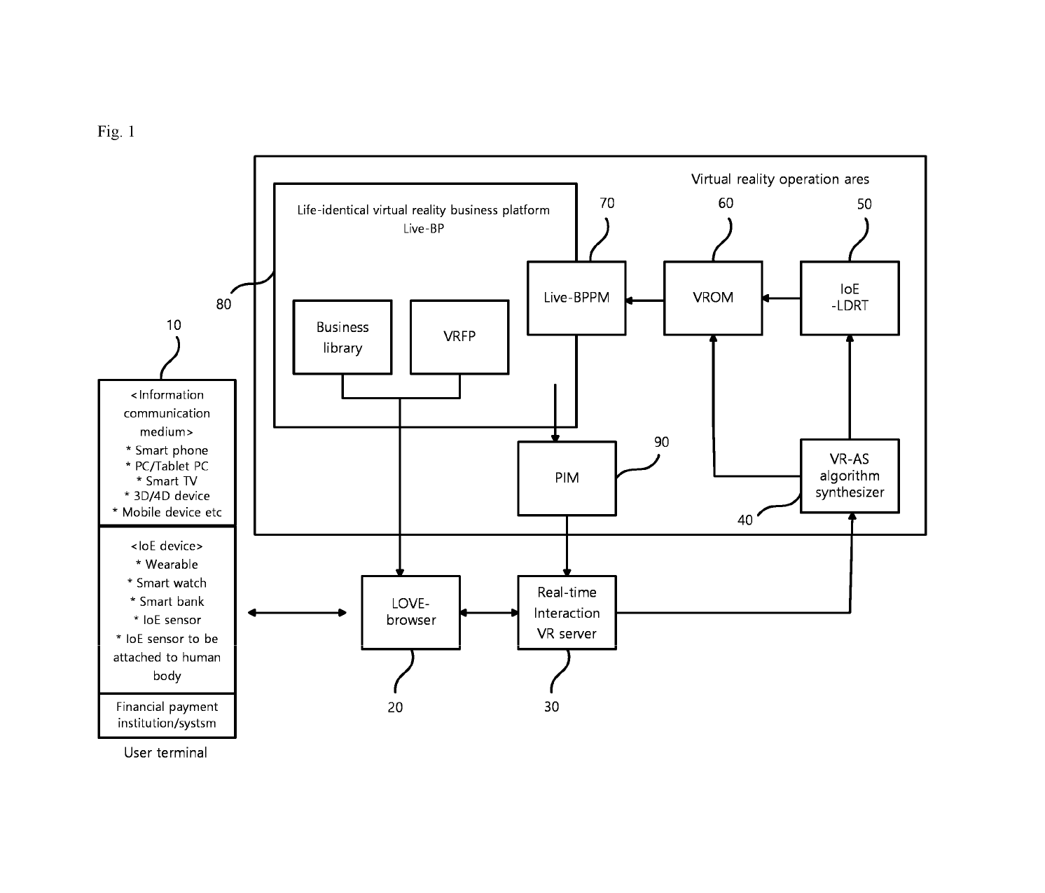

FIG. 1 is a view showing the overall configuration of a life-identical virtual reality business platform Live-BP operation according to an embodiment of the present invention.

Referring to FIG. 1, the operation of the life-identical virtual reality business platform Live-BP according to an embodiment of the present invention is performed by including a user terminal 10, a LOVE-browser 20, a real-time interactive virtual reality server 30, an algorithm synthesizer 40, an IoE-LDRT 50, a virtual reality optimization management 60, a Live-BPPM 70, a life-identical virtual reality business platform region 80, and a platform insight management 90.

The LOVE-browser 20 is a virtual reality browser which integrates and operates all the information including the information on an IoE device connected via the user terminal 10 to support a multi-channel operation, 3D scans a user (an actual person) and a spatial image constituting virtual reality to operate and manage scan information, and connects and links the real world with the Live-BP 80 in order to use the life-identical virtual reality business platform (Live-BP) 80.

In addition, the LOVE-browser 20 is a browser that uses the Live-BP 80 to implement 4D (feel, senses, emotions, etc.) by connecting and linking with the actual real world via all wearable devices (smart watches, smart bands, IoE sensors attached to human bodies) in an IoE-merged environment.

The real-time interactive virtual reality server 30 provides and manages in real time data to be interacted with and data required for virtual reality in using information introduced from the LOVE-browser 20 in the life-identical virtual reality business platform (Live-BP) 80.

The VR-AS (the algorithm synthesizer) 40 classifies algorithm information introduced from the real-time interactive virtual reality server 30 and merges an algorithm of data derived from the IoE device and a virtual reality operational general data algorithm, thereby combining, synthesizing and optimizing the algorithms to generate eight algorithm classification areas so as to be utilized in the Live-BP 80.

The IoE-LDRT 50 implements 4D (sense, feel, emotion, etc.) in a wearable device consistent with a wearable-compatible code generated from the LOVE-browser 20 in an IoE algorithm (algorithm such as space, environment, an object constituting virtual reality) that needs to interact with an biometric bio-algorithm related to a person to react, the biometric bio-algorithm which has been introduced from the VR-AS 40.

The VROM 60 is a step of configuring and managing a virtual reality platform that configures and manages the virtual reality environment and the business platform optimized for Live-BP 80 operation in algorithms introduced from the VR-AS 40 and the IoE-LDRT 50.

The life-identical virtual reality business platform (Live-BP) 80 is such that optimized virtual reality platforms configured in VROM 60 are executed by Live-BPPM 70, so that living the same life in virtual reality in which the Internet of Everything (IoE) is merged and operated and in the real world is possible, thereby allowing the virtual reality and the real life to be linked to lead social and cultural life such as business.

The PIM 90 is a step of collecting and analyzing responses and morphological information of a platform taking place in the Live-BP 80 and inspecting and managing a generated platform by feeding back business data to a user who uses the platform.

The details of the configuration and operation of the life-identical virtual reality business platform merged with the Internet of Everything (IoE) are as follows.

In FIG. 1, the user terminal 10 refers to a variety of information communication means for a user to experience, use, and operate the life-identical virtual reality business platform 80.

The information communication means according to the embodiment of the present invention includes smart phones, PCs/tablet PCs, smart TVs, IoE devices (wearables, smart watches, IoE sensors, and devices operated by IoE software), 3D/4D devices, financial payment institutional systems and other payment systems, and all the objects, people, environment, and the like that are routinely contacted via the IoE device are interconnected with the life-identical virtual reality business platform (Live-BP) 80 and data derived from a process of transmitting information to each other is provided to the user by the user terminal 10.

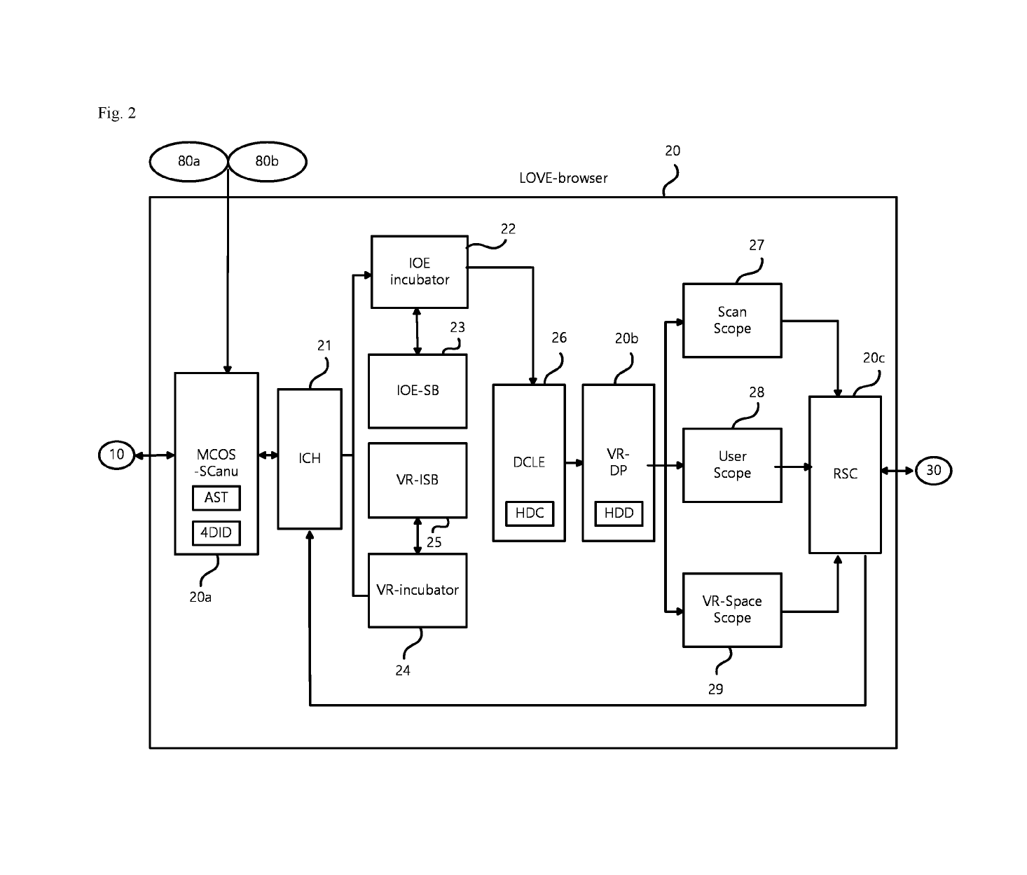

FIG. 2 is a view showing the configuration of the LOVE-browser 20 according to an embodiment of the present invention.

Referring to FIG. 2, the LOVE-browser 20 will be described.

The LOVE-browser (Live Open Virtual Reality Environment Browser) 20 is a life-identical virtual reality browser that connects and links virtual reality in which the Internet of Everything (IoE) is merged and operated with the actual real world via the user terminal 10, thereby allowing the use of the same vivid virtual reality as the reality.

The LOVE-browser 20 is a virtual reality operational step in which users, IoE devices, and the like which use the life-identical virtual reality business platform (Live-BP) 80 use the LOVE-browser 20 via the user terminal 10, and is a virtual reality browser which merges virtual reality information introduced from the user terminal 10 with the function of the IoE device and operated in an IoE sensor and uses the life-identical virtual reality business platform (Live-BP) 80 according to an embodiment of the present invention.

In addition, in using the Live-BP 80 via an IoE device, the LOVE-browser is connected and linked with various IoE devices regardless of IoE dedicated apps or IoE dedicated software to use and operated the life-identical virtual reality business platform 80.

Conventional virtual reality has been operated through hardware devices, such as virtual reality displays like the head mount display HMD and the like, or by some on-line virtual reality sites. In addition, in conventional virtual reality, the IoE, in which objects constituting virtual reality communicate information with each other, has not been operated. Virtual reality up to the present has been operated only by limited operational devices or operating systems (OS) and experienced, and has a limitation of not being used by various IoE devices anytime, anywhere.

According to an embodiment of the present invention, in order to overcome the limitation, the LOVE-browser 20 has been invented to allow information communication in virtual reality with an actual real world via IoE devices, and allow the IoE to be merged anytime and anywhere via various IoE devices, not via unified devices or on-line sites, so that it is possible to use life-identical virtual reality in which an actual real life can be operated and used in a virtual reality world.

The life-identical virtual reality may be used anytime and anywhere only if the LOVE-browser 20 is operated in the user terminal 10.

Referring to FIG. 2, the LOVE-browser 20 includes an MCOS-Scanu 20A, a multi-channel operating system in which various data introduced from the user terminal 10 is merged and integrated to configure various operational channels for using virtual reality, thereby supporting multi-channel operation, and which scans user's appearance and spatial images to operate scan information, a 4DID which uses the Live-BP 80 among components of the MCOS-Scanu 20A and connects and links an actual real world via every IoE wearable to allow a spatial environment and the like in which an actual space is implemented as it is has the same feel when using the Live-BP 80, an ICH 21 which classifies data into data derived from IoE devices (wearables, IoE sensors, etc.) and virtual reality operational data (users, business entities, spatial image data, etc.) according to the structure and characteristics of the data,

an IoE Incubator 22 which loads and manages only IoE-related data derived from IoE devices, an IoE-SB 23 which is an IoE security management system in operating virtual reality merged with the IoE, a VR-Incubator 24 which loads and manages virtual reality operational data (spatial image data, user data, business data, etc.), a VR-ISB 25 which is a security management system for ensuring the security and safety of the virtual reality operational data, a DCLE 26 which is a data compatible in which data of the VR-incubator 24 and data of the IoE incubator 22 are integrated and become compatible, a VR-DP 20B which is a virtual reality division program that divides data according to three areas for operating the life-identical virtual reality business platform Live-BP 80, a Scan Scope 27 which standardizes and manages scan data, a User Scope 28 which standardizes and manages user data, business data, and virtual reality general data, a VR Space Scope 29 which configures spaces or environments constituting virtual reality, a RSC 20C which is a real-time linkage that compatibly integrates data from the Scan Scope 27, the User Scope 28 and the VR Space Scope 29, and transmits information in real time, wherein the LOVE-browser 20 is operated in the user terminal 10 and use the life-identical virtual reality business platform (Live-BP) 80.

In order to experience and use the life-identical virtual reality business platform (Live-BP) 80, the MCOS-SCANu (Multi-Channel Operating System Scan Unite) 20, which is a multi-channel operating system, compatibly operates virtual reality operational data introduced from the user terminal 10 and data derived from IoE devices to configure channels such that various user terminals used by a user are automatically recognized, linked and operated, and uses virtual reality and performs information communication in the configured corresponding channel.

In the above, the virtual reality operational data includes user information required to operate virtual reality, information on space constituting the virtual reality, and all business information, and the IoE data means object data that communicates information in various IoE sensors, including a person's biometric data derived from an IoE device.

The MCOS-SCanu 20A is a step of integrating and processing the IoE-derived data and the virtual reality operational data, and with compatible linkage of multi-channel operating systems (Windows, Android, IOS, IoE sensor software, IoE-dedicated apps, mobile operating systems, etc.), virtual reality between multi-channels may be freely and easily operated. In addition, the MCOS-SCanu 20A is a step of scanning user's appearance and spatial image information, and systematically managing scanned information to provide for the Live-BP 80 operation.

In addition, the MCOS-SCanu 20A is designed in a distributed structure so that two-way communication is easily implemented, and controls the amount of data and ensures continuity thereof to prevent network load, thereby connecting and operating various and vast data introduced from the user terminal 10 and a large number of users without overload.

The MCOS-SCANu 20A is a technical step of implementing a scan function in a browser operated in multiple channels, and with the browser and the scan function merged, 3D scans all the environments constituting virtual reality through the LOVE-browser 20 operated in the user terminal 10, thereby implementing space and user's appearance constituting the Live-BP 80.

According to an embodiment of the present invention, in the above, an AST is applied as a technique of implementing 3D scan so as to merge the browser and the 3D scan function.

The AST (Autofocus Scanning Tool) is a scan tool which implements a 3D scan function in a browser such that the browser and the scan function are merged.

The AST has a multi-channel image sensor function to support and operate the user terminal 10 and with strong optical performance as that of a camera, and implements clear images and scans from people to landscapes or environments from various angles. In addition, the AST provides fast and seamless integration connectivity anytime, anywhere.

When a user uses the Live-BP 80, a method of scanning the user's own appearance or spatial backgrounds constituting the Live-BP 80 is to select the AST from the open manual of the LOVE-browser 20 operated in the user terminal 10 to perform scanning, thereby scanning, with various user terminals 10, the user's appearance (the user's face and left, right, front, and back) or scanning spatial images and the like such as a plurality of people, things, environments, and the like constituting a virtual space, and the AST manages scan information which is interconverted with multi-channels and operated.

In addition, the MCOS-SCanu 20A includes a step in which the scan information scanned in the AST and external photographing information (user scan information, spatial image information, etc.) introduced via the user terminal 10 are automatically linked such that users may freely configure spatial backgrounds in the Live-BP 80.

According to an embodiment of the present invention, when using the Live-BP 80 via the user terminal 10 in which the LOVE-browser 20 is operated, sense, touch, and feel of all the environmental objects that are implemented with the actual real world environments may be felt through the 4DID (4D interaction device), which is a component of the LOVE-browser.

The 4DID (Fourth Dimension Interaction Device) generates a wearable compatible code WCC when inputting information (types and device information) of wearables (smart bands, smart watches, IoE sensor devices attached to human bodies, etc.) worn by a user and used in a real world, and manages information of the wearables used by the user to implement 4D (feel, touch, emotions, etc.) while using the Live-BP 80.

The wearable compatible code is generated to manage wearable information by giving a unique code to a wearable so as to smoothly communicate 4D information implemented in the Live-BP (80) with a wearable used in the actual real world.

The generated wearable compatible code is sent to the IoE-LDRT 50 and is matched with an object to interact with a wearable corresponding to the given code, thereby being matched with a wearable worn by a user in an actual real world and with all the things operated in the Live-BP 80, so that interaction 4D (touch, feel, emotions, etc.) is implemented.

In addition, a step of, when the wearable compatible code WCC is generated, downloading the 4DID of the LOVE-browser 20 on a corresponding wearable worn by a user so as to be compatibly operated is included.

The MCOS-SCANu 20A includes a step of smoothly supplying and linking data introduced from the business library 80A and the VRFP 80B to a corresponding operation channel in real time, and includes a step in which insight information on platforms taking place in the Live-BP 80 is introduced via the PIM 90 to the MCOS-SCanu 20A to be delivered to users and business entities with business information taking place in virtual reality and virtual reality experience information and the like via the user terminal 10, such that information of virtual reality is fed back to the users and platform operators. The information of the MCOS-SCanu 20A is automatically sent to an ICH 21.

The ICH (IoE Connect Hub) 21 is a step of classifying according to the structure, characteristics and derived objects of data introduced from the MCOS-SCanu 20A, which is a step of classifying data derived from IoE devices and virtual reality operational data to send the IoE device-derived data to the IoE incubator 22 and send the virtual reality operational data (user data, business data, spatial images, etc.) to the VR-incubator 24.

The data introduced from the MCOS-SCanu 20A is diverse and vast. Since the data are composed of different structures and characteristics, the compatibility of the data is low and the operating methods thereof are different, so that it is difficult to integrate the data. To solve this problem, according to an embodiment of the present invention, the ICH 21 has been invented to automatically classify data into IoE device data and virtual reality operational data according to derived objects and operating methods of the data.

In addition, the IoE device-derived data introduced from the MCOS-SCANu 20A and the virtual reality operational data have different structural characteristics, so that it is difficult verify and guarantee the security and safety of the data. According to an embodiment of the present invention, the ICH 21 classifies the IoE device-derived data and the virtual reality operational data to manage security and data according to the characteristics of the data, thereby solving the security problem. As a result, it is possible to execute security for all the IoE devices using the Live-BP 80 and the IoE with an IoE device.

Data derived from IoE devices and classified in the ICH 21 are sent to the IoE incubator 22, and general data (data such as user data, business related data, spatial images) for operating virtual reality are sent to the VR-incubator 24, automatically.

In addition, a step is included in which among the data introduced from the RSC 20C, data to be transmitted to a user in real time is sent to the MCOS-SCANu 20A for real-time feedback to the user terminal 10.

The IoE Incubator 22 is a step of loading and managing only the IoE-related data derived from IoE devices introduced from the ICH 21. Since the data derived from IoE devices are unstructured data which are different for each device, sensor, and use area, a data integrity processing DIP is performed to prevent situations in which data processing is not smoothly performed during data collision or loading, so that the IoE device-derived data are sequentially managed.

In the above, the data integrity process is a data processing technology which manages such that loading is performed according to the specificity of data and, preserves the properties of data when the loaded data is transmitted by correlation or interaction.

In addition, the IoE incubator 22 is a step of classifying the IoE data introduced from the ICH 21 according to characteristics of data related to living bodies such as body, emotions, five senses and the like of a person and data related to physical objects such as things, space, sensors, environments, natural ecology and the like, thereby creating an environment for performing a conversion operation for compatibility with heterogeneous data with different sizes and properties of data.

In the above, the classification of data related to living bodies classified according to the characteristics of data automatically classifies data detected in real time by various biometric signals including psychological condition, favorability, feel, touch, and the like derived from IoE devices (wearables, IoE sensors, smart watches, smart learning devices, etc.), and is managed by including biometric data implemented in the IoE-LDRT 50 and derived from a user wearable.

In addition, a step is included in which data is automatically sent to the IoE-SB 23 for the verification and security of the data, and data verified for security in the IoE-SB 23 and thus, guaranteed security, is automatically transmitted to the DCLE 26.

The IoE-SB (IoE-Secure Box) 23 is a virtual reality IoE security system which checks vulnerability such that any errors or failures do not occur due to the IoE data introduced from the IoE incubator 22, and prevents security accidents such as infringement.

As the IoE has been gradually spread, security threats have increased sharply. However, the reality of IoE security is that the technology base thereof is weak to respond to and analyze security threats.

According to an embodiment of the present invention, the IoE-SB 23 has been invented to solve the vulnerability of IoE security and to create an environment for real-time monitoring and analysis of malicious codes and hacking tools hidden in data introduced from IoE devices, thereby preventing infringement accidents by hacking and using malicious codes.

In the past, an IoE operating system OS such as an IoE device and an IoE sensor has a problem of being vulnerable to security. In addition, a conventional IoE security system having no virtual reality merged with the IoE has a limitation in operating virtual reality in which the IoE is merged. According to an embodiment of the present invention, by designing the IoE-SB 23 which is an IoE security system based on IoE security in a virtual reality environment in which the IoE is merged, it is possible to solve security issues of the IoE operated in conventional virtual reality.

The security system of the IoE-SB 23 is connected to a plurality of types of IoE devices and to the user terminal 10, thereby being applied not only to the IoE operated in virtual reality such as IoE devices and IoE software operated in the Live-BP 80 but also to IoE devices linked to a real world to quickly detect and block threatening factors.

The IoE-SB 23, which is an optimal security system for operating virtual reality merged with the IoE, is a step of blocking hacking tools, malicious codes, transformed data, spam mail, viruses, and the like, thereby blocking data leakage and data destruction, data transformation and the like.

In addition, it is more difficult to cope with security threats since the IoE has different operating systems (OS) and applications used for each device. Most IoE devices use an embedded Linux operating system (OS), and since infection pathways of embedded malicious codes are unknown so that it is difficult to find causes thereof, and unlike Windows systems, most embedded Linux devices do not use security programs and do not have dedicated security products.

In order to overcome the above limitations, according to an embodiment of the present invention, the IoE-SB 23 has been invented to analyze and block in real time threat information that may be present in IoE devices, IoE sensors, IoE services, IoE applications, and the like.

Due to the IoE-SB 23, which is a security system applied to an environment in which the IoE and virtual reality are merged, it is possible to solve information security problems of the IoE operated in the Live-BP 80. Due to the IoE-SB 23, vast amount of data poured from many IoE sensors and devices are analyzed with a dynamic analysis function of IoE data, so that failure generating factors may be responded to in advance and eliminated.

When a user operates the Live-BP 80, since industrial infrastructure operated in various platforms configured in the Live-BP 80 or industrial infrastructure operated in an environment merged with the IoE and in actual reality is linked and operated with an environment merged with the IoE, the IoE-SB 23 manages security by establishing systematization of the security of industrial infrastructure and IoE merged network.

In addition, in order to allow platforms operated in the Live-BP 80 to operate without interruption by external attacks, the IoE-SB 23 ensures immediate and constant restoration, and analyzes and responds to in real time failure factors of gateways, nodes, sensors and the like which have security vulnerability.

To send IoE data verified for security in the IoE-SB 23, back to the IoE incubator 23, a step of automatically sending data to the DCLE 26 is included.

The VR-Incubator 24 is a step of loading and managing virtual reality operating data (user data, spatial image data, virtual reality business data, payment information data, etc.) introduced from the ICH 21.

To stabilize complex and a large amount of virtual reality operational data introduced from the ICH 21 and to allow the virtual reality operational data to be sequentially and smoothly operated, compatibility of that data is maintained.

In addition, the VR-Incubator 24 includes a step of sending data to the VR-ISB 25 for the verification and security of the data, and automatically transmitting data verified for security in the VR-ISB 25 and thus, guaranteed security, to the DCLE 26.

The VR-ISB (VR-Interflow Secure Box) 25 is a virtual reality security system which ensures security and safety of the virtual reality operational data (spatial image data, user data, payment information data, etc.) introduced from the VR-incubator 24.

A conventional virtual reality data security system uses a static method (fixed source) in which data and servers send and receive measurement values and monitor the data. However, according to an embodiment of the present invention, the VR-ISB 25 is an intelligent security system in which a real-time secure module is automatically installed in real time for the security and integrity of data according to the execution or properties of virtual reality operational data, thereby enhancing the security of the data, and after a certain period of time, another new real-time secure module is created to perform security verification.

Due to the real-time secure module, it is possible to protect real-time and various virtual reality operational data introduced from the user terminal and operated.

In addition, a conventional virtual reality security application or security program uses a method in which an authentication server protects a valid program and an application only for a predetermined time only while being executed. However, according to an embodiment of the present invention, the VR-ISB 25 is a security system, with a real-time automatic tracking function by a dynamic-based security module system method, which ensures safety from malicious codes or hacking attacks trying to tamper the operating system (OS) of a device or an application using virtual reality.

It is a step in which, due to the VR-ISB 25, all users and business entities using the Live-BP 80 via the LOVE-browser 20 secures the safety of virtual reality operational data.

In addition, the VR-ISB 25 blocks abnormal behavior (pattern) by type of each data and file abnormal behavior according to the characteristics of each data which are introduced from the outside such as the user terminal 10 for using the Live-BP 80, and in order to protect the data, prevents the threat of all files introduced from various external paths, that is, the user terminal 10.

In the above, when there is abnormal file behavior, data is isolated, protected, monitored, tracked, and blocked so as to fundamentally prevent files introduced from the outside and including malicious codes from accessing critical areas such as systems and virtual reality operations.

Data verified for safety and security of data in the VR-ISB 25 is sent back to the VR-incubator 24. It is a cyclic security management system in which when the data verified for security in the VR-ISB 25 has abnormality in the security and integrity of virtual reality operational data in the VR-incubator 24, in order to fundamentally block abnormal data, the data is sent back to the VR-ISB 25 to be verified for security again.

A conventional security management system uses a fragmented security verification method in which data is utilized and sent to critical system areas once a primary verification is completed in a security system, and therefore, when there is a problem with a primary security system network, the entire system fails. However, in an embodiment of the present invention, the VR-ISB 25 and IoE-SB 24 are cyclical verification systems which are virtual reality operation security systems ensuring the safety and integrity of data, so that it is a step capable of securing the safe security of users and business entities using the Live-BP 80.

Data verified in the VR-ISB 25 to have no security problems is sent back to the VR-incubator 24, and a step of transmitting the data to the DCLE 26 is included according to the utilization of the data.

The DCLE (Data Compatible Linkage Editor) 26 is a data compatible device for integrating and compatibly linking data introduced from the IoE incubator 22 and the VR-incubator 24, which interconverts and links the IoE device-derived data and the virtual reality operational data such that the IoE device-derived data and the virtual reality operational data are smoothly integrated and operated without collision between the data.

The IoE device-derived data and the virtual reality operational data introduced from the user terminal 10 for using the Live-BP 80 are diverse and vast. Since the data are composed of different structures and characteristics, the compatibility of the data is low, so that it is difficult to integrate the data.

In order to solve the above problem, according to an embodiment of the present invention, the DCLE 26 has been invented such that data is classified into data having the same characteristics according to the characteristics of data and data derived objects and integrated and operated, and correlations and connections between the data are derived, visualized, and standardized to allow biometric bio-data, object, space, physical data and virtual reality operational data to be compatible, thereby performing integration and overconverting data for operating the Love-browser 20 in which IoE data and the virtual reality operational data are merged to enable a smooth operation of virtual reality.

Conventionally, in a real world including virtual reality, there has been a limitation in integrating and operating since IoE devices (wearables, IoE sensors, smart watches, smart bands, etc.) have different manufacturers, operating systems (OS) and operating programs. In addition, there has been a technical limitation in operating IoE devices implemented in an environment in which the IoE and virtual reality are merged.

According to an embodiment of the present invention, the DCLE 26 has been invented to overcome the above limitations, and is a basic step in which users using virtual reality merge and overconvert IoE data introduced through the user terminal 10 and virtual reality data (spatial image data, user data, business information, payment data, etc.) operated in the Live-BP 80, thereby enabling information communication between IoE devices implemented and operated in Live-BP 80 and IoE devices operated in the real world.
In addition, the DCLE 26 enables heterogeneous data having different sizes and characteristics of data to be combined and compatible.

In the above, as a method for integrating and overconverting heterogeneous data, all the data become compatible by a HDC (Heterogeneity Data Compatible) which enables heterogeneous data having different sizes and characteristics of data to be combined and compatible.

It is a basic step in which, due to the HDC (heterogeneous data compatible) operated in the DCLE 26, an actual spatial image implemented in the Live-BP 80 and IoE devices operated therein allow all users who use the user terminal 10 in which the LOVE-browser 20 is operated to use the IoE devices and exchange services in the Live-BP 80. A step is included in which the IOE device-derived data and the virtual reality operational data which are integrated and compatible in the DCLE 26 are sent to the VR-DP 20b.

The VR-DP (VR-Divide Programming) 20B is a data division program which divides data introduced from the DCLE 26 according to an operation area of data in order to operate the Live-BP 80.

In the above, the data operation areas divided for operating the Live-BP 80 is classified into a scan (user/spatial image) area in which a user configuring the environment of the Live-BP 80 and spatial image data are scanned, a user (business entity) area, who is the subject of use of the Live-BP 80, a virtual reality environment (spatial data) area constituting the background of the Live-BP 80 to perform standardization and sorting operations of data by each area.

The data introduced from the DCLE 26 is non-standardized data. In order to operate the Live-BP 80, it is suitable to standardize unstructured data and sort the data to operate the Live-BP 80.

For the above reason, the VR-DP 20B has been invented. According to an embodiment of the present invention, due to the VR-DP 20B which sorts, standardizes, and automatically divides data by operation area in order to create a data form suitable for operating the Live-BP 80, a data form suitable for configuring and operating the Live-BP 80 is obtained.

Data standardization and classification technique in conventional virtual reality is a method of classifying and standardizing by data mining according to data records and data single association, and has a limitation in classifying and standardizing data in a virtual reality environment in which data derived from IoE devices (IoE sensors, wearables, smart watches, etc.) is merged.

According to an embodiment of the present invention, due to the VR-DP 20B, it is possible to overcome the limitation and to standardize and sort data for operating virtual reality in an environment in which the IoE is merged, and standardize even IoE data (biometric data) derived from IoE devices.

The VR-DP 20B is a large amount of unstructured data division program which classifies not only data simply structured with a division technique of data by properties and associativity of data, but also unstructured data such as IoE device-derived data or a large amount of data to automatically extract data required for three data operation areas for operating the Live-BP 80 with the HDD (Homogeneity Data Divide). The HDD (Homogeneity Data Divide) is an IoE data division technology which divides only the homogeneous data having the same properties.

Data related to the divided data areas in the VR-DP 20b is sent to the Scan Scope 27, the User Scope 28 and the VR-Space Scope 29, respectively.

The Scan Scope 27 is a step of standardizing and managing the user scan data and the spatial image scan data which are divided in the VR-DP 20B and introduced therefrom. As a result, in configuring, operating, and using the Live-BP 80, all the scan data is managed in a suitable form of data and supplied. A step is included in which data standardized in the Scan Scope 27 is sent to the RSC 20C.

The User Scope 28 is a step of standardizing and managing the user data, business data, virtual reality operational general data which are divided in the VR-DP 20B and introduced therefrom. As a result, in configuring, operating, and using the Live-BP 80, the user data, business data, virtual reality operational general data is managed in a suitable form of data and supplied. A step is included in which data standardized in the User Scope 28 is sent to the RSC 20C.

The VR-Space Scope 29 is a step of standardizing and managing virtual reality spatial environment-related data such as spatial image data and IoE device-derived data constituting the space of the Live-BP 80 which are divided in the VR-DP 20B and introduced therefrom.

As a result, in configuring, operating, and using the Live-BP 80, among the spatial image data and the IoE device-derived data, data constituting the space and environment of the Live-BP 80 is managed in a suitable form of data and supplied. A step is included in which data standardized in the VR-Space Scope 29 is sent to the RSC 20C.

The RSC (Real-time Stream Connector) 20C is a real-time connector which merges and interconverts data introduced from the Scan Scope 27, the User Scope 29, and the VR-Space Scope 29 and delivers merged and interconverted data in real time to the Real-time Interaction virtual reality (VR) server 30. The RSC 20C is a real-time connector for connecting to the Real-time Interaction VR server 30, and integrates the virtual reality operational general data required for the operation of the Live-BP 80 and the IoE device-derived data regardless of device, operating system (OS), or program, and provides the integrated data to the Real-time Interaction VR server 30 by automatic connection in real time. Due to the RSC 20C, the LOVE-browser 20 and the Real-time Interaction VR server 30 are automatically connected in real time, so that it is possible to use the Live-BP 80 through the user terminal 10 in which the LOVE-browser 20 is operated.

In addition, in order to solve a problem in which a large amount of data introduced in real time from the Scan Scope 27, the User Scope 28, and the VR-Space Scope 29 may be overloaded or there may be a problem in smooth interactive connection to the Real-time Interaction VR server 30, according to an embodiment of the present invention, the RSC 20C has been invented to eliminate the overload of data introduced from the Scan Scope 27, the User Scope 28, and the VR-Space Scope 29 and perform real-time information transmission due to the smooth interactive connection to the Real-time Interaction VR server 30. As a result, by facilitating the LOVE-browser 20, the Live-BP 80 may be operated and used in the user terminal 10.

A step is included in which data of the RSC 20C is transmitted in real time to the Real-time Interaction VR server 30.

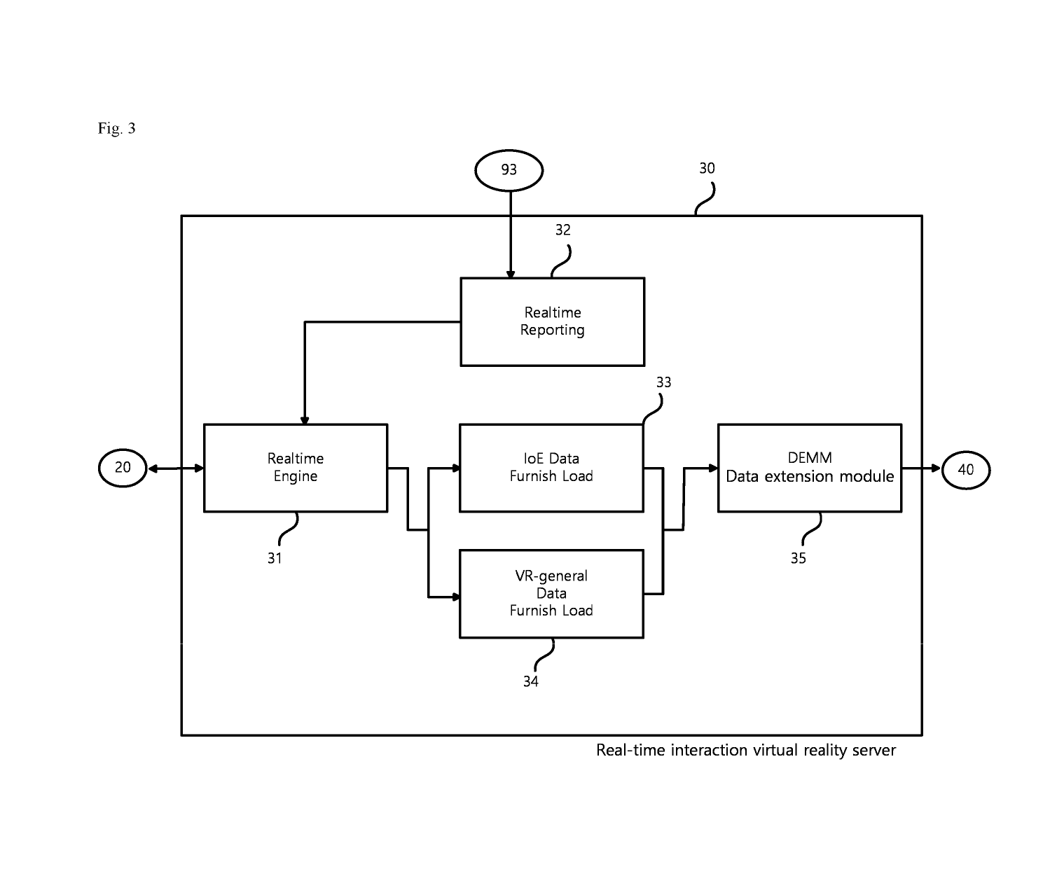

FIG. 3 is a view showing the configuration of Real-time Interaction VR server (a real-time interactive virtual reality server) 30 according to an embodiment of the inventive concept.

The Real-time Interaction VR Server 30 classifies data introduced from the RSC 20C to provide and operate in real time data to be interacted when using the Live-BP 80. In the above, the classification of data is performed such that data is loaded by being classified into IoE device-derived data and virtual reality operational data, and supplied in real time to the Live-BP 80 when necessary. It is a step in which diverse and vast IoE device-derived data and virtual reality operating data are processed and expanded, thereby securing the security of the data.

The Real-time Interaction VR server 30 delivers all the situations taking place in the Live-BP 80 to the LOVE-browser 20 and the VR-AS 40 in real time, such as data and business forms that need to interact while a use uses the Live-BP 80 such that real-time feedback between the user and the Live-BP 80 is performed.

Referring to FIG. 3, the configuration of the Real-time Interaction VR server 30 is configured by including a Real-time Engine 31, a Real-time Reporting 32, an IoE Data Furnish Load 33, a VR-General Data Furnish Load 34, and a Data Enlargement Modeling Module 35. The Real-time Engine 31 is a real-time interactive virtual reality data processing engine for operating the Live-BP 80 in which the real-time interaction of a large amount of data introduced from the RSC 20C is achieved.

The Real-time Engine 31 classifies IoE device-derived data such that IoE devices (wearables, smart watches, IoE sensors, etc.) operated in the Live-BP 80, IoE sensors operated in a real world, and the user terminal 10 used by a user detect situations in real time to exchange data with each other by a real-time interaction to be suitable for the situation of a user using the Live-BP 80.

For the operation and use of the Live-BP 80, data introduced from the RSC 20C should be processed in real time, real-time information communication by interaction between all the businesses taking place in the Live-BP 80 or entities using and operating the Live-BP 80 should take place, and real-time processing of data should be performed in an environment in which IoE devices are merged.

According to an embodiment of the present invention, the Real-time Engine 31 has been invented to allow a user entity (business entity), IoE devices and the like to smoothly communicate information by interaction when using all the businesses and virtual reality taking place in the Live-BP 80 merged with the IoE.

In addition, the Real-time Engine 31 includes a step of sending platform insight data introduced from the Real-time Reporting 32 to the RSC 20C, which is a component of the LOVE-browser 20, in order to deliver the same to the user terminal 10.

In addition, the Real-time Engine 31 includes a step of classifying data introduced from the RSC 20C to send the IoE device-derived data to the IoE Data Furnish Load 33 and the virtual reality operational data to the VR-General Furnish Load 34.

The Real-time Reporting 32 is a step in which data introduced from the PIM 93 is sent to the Real-time Engine 31 such that real-time feedback is provided to users, business entities, and IoE sensors which use the LOVE-browser 20 and the Live-BP 80, and immediate visualization is performed from the perspective of the users and the business entities in order to collect and inspect business information and virtual reality information.

The Real-time Reporting 32 manages data introduced from the PCM 93, and when a user of the Live-BP 80 requests relevant data or business information when executing a business, extracts real-time business-related information from the PCM 92 and send the extracted information to the LOVE-browser 20 or the Live-BP 80 in real time, so that feedback is provided between the users and the business entities.

In addition, the Real-time Reporting 32 delivers information of various platforms taking place in the Live-BP 80 to the LOVE-browser 20 and visualizes data to show to a user, and the visualized business information is fed back and utilized such that businesses proceed smoothly in the Live-BP 80.

Due to the above, the Real-time Reporting 32 provides information such that all business information taking place in the Live-BP 80 is connected to businesses operated in an actual world, and supports such that the Live-BP 80 and the actual real world are simultaneously linked to execute businesses by interaction.

In addition, the Real-time Reporting 32 sends, among data introduced from the PCM 93, data that needs immediate feedback to the Live-BP 80 to the Real-time Engine 31 so as to be sent to the IoE Data Furnish Load 33 and the VR-General Data Furnish Load 34.

The IoE Data Furnish Load 33 is a step of loading and managing only the data derived from the IoE devices (wearables, smart watches, smart bands, IoE sensors, etc.) introduced from the Real-time Engine 31 and providing data necessary for the Live-BP 80 in real time.

The IoE Data Furnish Load 33 manages all business-related data made through IoE devices, and immediately supplies the data to the Live-BP 80 according to the arrangement of data to be provided in real time, requirements of users (business entities) or information communication objects, and the processing capability of the user terminal 10 and IoE sensors capable of real-time processing of IoE data.

A step is included in which the data of the IoE Data Furnish Load 33 is automatically sent to the DEMM 35.

The VR-General Data Furnish Load 34 is a step of loading and managing data related to the virtual reality operational general data (users, spatial images, businesses, other virtual reality experiences, etc.) introduced from the Real-time Engine 31, thereby providing data necessary for the Live-BP 80 in real time.

The VR-General Data Furnish Load 34 performs, according to the requirements of users and information communication objects using the Live-BP 80 and the characteristics of related-businesses, real-time data processing to arrange and provide data to be provided to the Live-BP 80, and allows two-way information communication by real-time interaction to proceed smoothly.

In the above, the two-way information communication provides, when data is linked according all business utilization taking place in the Live-BP 80 due to immediate information delivery by interaction between users using the user terminal 10 or an IoE sensors and the like and users, business objects, IoE devices and the like using the Live-BP 80, data necessary for various information providing services, business activity support, and virtual reality experience.

A step is included in which the data of the VR-General Data Furnish Load 34 is automatically sent to the DEMM 35. The DEMM (Data Enlargement Modeling Module) 35 is a step in which data introduced from the IoE Data Furnish Load 33 and the VR-general Data Furnish Load 34 is integrated and expanded, and the modeling of data for the smooth merge of algorithms is performed in the VR-AS 40.

The DEMM 35 is a data modeling module which, in order to prevent a phenomenon of excessive large data and overload in data processing, standardizes the structure of data, thereby securing the scalability of data and maintaining the stability thereof.

Since the amount of data for operating the Live-BP 80, the data introduced from the IoE Data Furnish Load 33 and the VR-General Data Furnish Load 34 is large, when using a server operated in conventional virtual reality, a data processing overload problem occurs due to a phenomenon of excessive data, and there is a limitation in applying to the Live-BP 80 operated in an environment merged with the IoE, from which diverse and vast data is derived, for implementing the IoE and operating the Live-BP 80.

In order to overcome the limitation, according to an embodiment of the present invention, the DEMM 35 has been invented to standardize the structure of data, thereby securing the scalability of data, and to prevent overload, thereby maintaining the stability thereof.

In addition, in order to support the user terminal 10 which is an information communication medium for using the Live-BP 80 and to operate the Live-BP 80 which requires an environment configuration of large memory, high speed memory with high data processing speed, and large capacity, according to an embodiment of the present invention, the DEMM 35 applies data extension structure to continuously expand data with high speed and large capacity so as to allow mass data processing in an environment merged with the IoE.

The DEMM 35 is a step of standardizing the structure of data in order to integrate and interconvert data of the IoE Data Furnish Load 33 and the VR-General Data Furnish Load 34, and to support algorithm merge taking place in the VR-AS 40. In the above, the standardization of data structure is performed by extracting data in real time and linking the same, the data required for the association between IoE device-derived data and virtual reality operational data and for the use environment of a user using the Live-BP 80.

The DEMM 35 performs modeling of data such that algorithms of different data among data introduced from the IoE Data Furnish Load 33 and the VR-General Data Furnish Load 34 are easily merged, and the modeling of data is performed by automatically identifying the characteristics of data, processing data such that algorithms of the IoE data and the virtual reality operational general data so as to be suitable for integrating algorithms of the IoE data and the virtual reality operational general data such that related algorithms are combined, stabilizing a large amount of data, and preserving and managing data to ensure the smooth operation thereof.

In order to allow the data of the DEMM 35 to be optimized and utilized according to requirements of users and business entities using the Live-BP 80 and of IoE devices operated in the Live-BP 80, a step is included in which optimized data is extracted and automatically transmitted to the ADT 41, which is a component of the VR-AS 40.

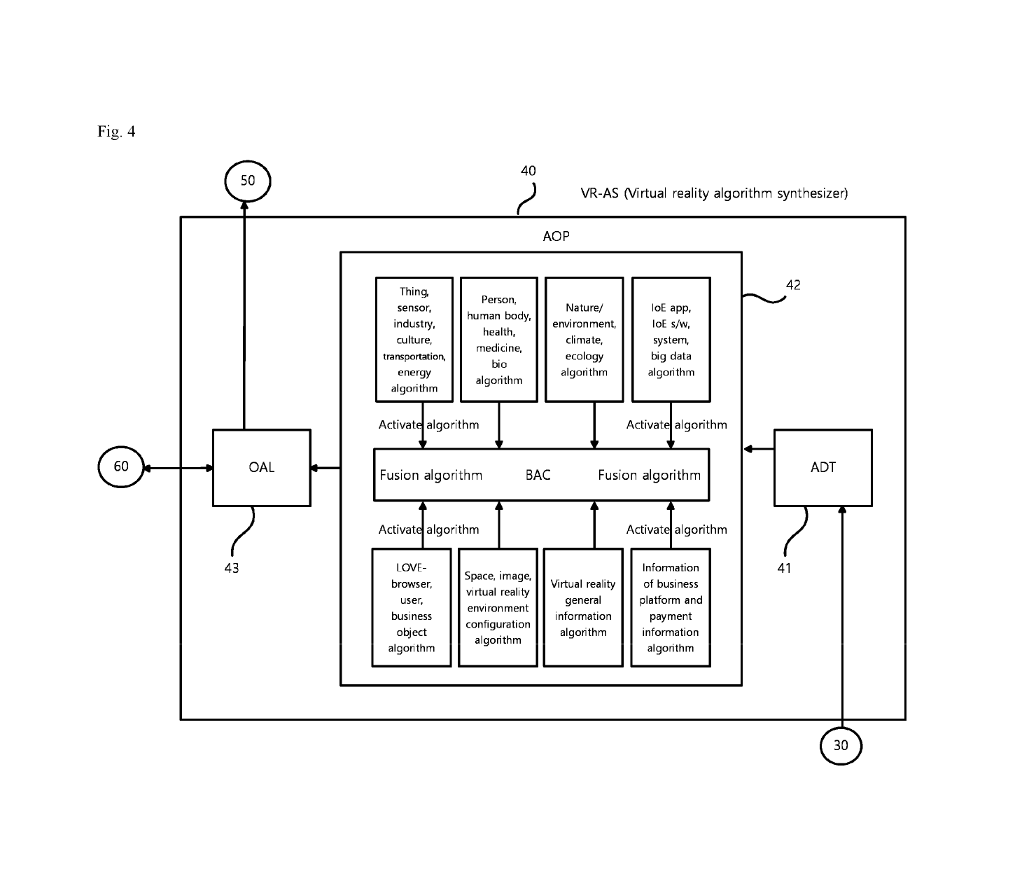

FIG. 4 is a view showing the configuration of the VR-AS 40 according to an embodiment of the present invention.

The VR-AS (Virtual Reality-Algorithm Synthesizer) 40 is a step of combining and synthesizing data algorithms introduced from the DEMM 35 to generate and synthesize an optimal algorithm necessary for the operation of the Live-BP 80, and is an algorithm synthesizer which allows algorithms derived from IoE devices and the general algorithms for virtual reality operation are synthesized to have the same structure, so that all algorithms are compatibly linked in using and operating the Live-BP 80.

Due to the algorithm synthesis performed in the VR-AS 40, IoE device-derived information is merged with platforms configured in the VROM 60 to implement the same business environment as in an actual real world, and therefore, when a user performs a business activity, experiences virtual reality and the like, algorithms are synthesized to compatibly link all the data such that the same business in the actual real world is connected and linked.

Due to algorithms synthesized above, in an environment in which the IoE is merged, virtual reality and an actual real world may be simultaneously linked to configure various platforms constituting the Live-BP 80 and to allow the Live-BP 80 to be executed.

In the IoE in which all objects and spatial environments that are generally accessible are connected, information about the properties and utilization of all the objects is measured and collected. The IoE is a super-connected society including reality, virtual and physical world and information world.

The operation and use of conventional virtual reality has been limited to means by which a user can input information, such as touch, character input, voice recognition, or a virtual reality experience device such as a HMD (head mount display). However, according to an embodiment of the present invention, the Live-BP 80, virtual reality merged with the IoE capable of information communication with various forms and devices, synthesizes by the VR-As, using a variety of IoE devices and IoE sensors 40. high-precision data algorithms that cannot be physically input by a person to connect and link an actual real world and a virtual reality world, thereby operating and using IoE devices operated therein.

Referring to FIG. 4, the VR-AS 40 is configured by including the ADT 41, an AOP 42, and an OAL43.

The ADT (Algorithm Divide Transaction) 41 is an algorithm division processing step of integrating and interconverting the IoE device-derived algorithms (IoE devices, IoE sensors, IoE s/w, etc.) introduced from the DEMM 35 and virtual reality operational algorithms (spatial images, users (business entities), payment information, and all business environments) to divide integrated and interconverted algorithms into algorithm areas having similar algorithm properties.

Business platforms configured in the Live-BP 80 and the type of businesses operated therein are the same as in an actual real world, and therefore, in order to execute the Live-BP 80, all data algorithms should be connected to the real world to perform interaction.

Since all algorithms should be synthesized and interconverted in order to perform interaction in the above, the ADT 41 generates algorithm areas having similar properties in order to create an environment in which algorithms may synthesize and interconvert themselves.

A step is included in which algorithms corresponding to the algorithm areas divided in the ADT 41 are sent to the AOP 42.

The AOP (Algorithm Optimization Process) 42 is an algorithm optimization processing step in which new algorithms are generated and synthesized for performing optimization processing on the algorithms so as to configure various platforms in the VROM 60 for configuring and operating the Live-BP 80 by utilizing algorithms which have been division processed in the ADT and introduced therefrom.

The AOP 42 combines algorithms in different algorithm areas divided by similar algorithms introduced from the ADT into a single form to generate and synthesize algorithms in order to perform optimization of virtual reality for configuring the Live-BP 80.

In the above, an algorithm which is generated during an initial work of combining algorithms into a single form in an initial algorithm synthesis process is an Activate Algorithm. The Activate Algorithm is an algorithm to become a source when heterogeneous algorithms according to similar characteristics and association with each other of the algorithms divided into eight algorithm areas in the AOP 42 form an algorithm DNA by themselves, thereby, as algorithms having new characteristics, synthesizing and merging IoE data.

The generated activate algorithm becomes a source of algorithm synthesis, which enables various and many algorithms introduced from the ADT 41 to operate and use the Live-BP 80 in an environment in which the IoE is merged.

According to an embodiment of the present invention, activate algorithms generated above are embedded with intrinsic characteristics of each algorithm, and thus, when meeting an algorithm having similar properties, the intrinsic characteristics embedded in the algorithms are activated, so that the algorithms automatically maintain the properties to generate information by means of rules and patterns between the algorithms and to merge the information. The plurality of activate algorithms above are combined and converted into a fusion algorithm.

As shown in FIG. 4, the AOP 42 is classified, according to the characteristics of algorithms introduced the ADT 41, into eight algorithm division areas, which are [(thing, sensor, industry, culture, transportation, energy), (person, human body, health, medical care, bio, etc.), (nature/environment, climate, ecology), (IoE app, IoE software, system, big data, etc.), (virtual reality operational general Information), (Love Browser user, business entity), (spatial image, virtual reality environment configuration), (business platform information, economic information, etc.)].

The AOP 42 is such that a large number of activate algorithms generated in the above 8 algorithm division areas are automatically merged with, according to the characteristics thereof, the same and similar activate algorithms, thereby, generating a fusion algorithm The fusion algorithm generated above is merged with a biometric bio-activate algorithm and a non-biometric general algorithm of a physical thing and the like to form a BAC (Bioactive Algorithm Compound) algorithm merge.

The Fusion Algorithm generated in the AOP 42 is such that many activate algorithms merge themselves to create embedded information and generate information which is needed for and interacted with the Live-BP 80, thereby forming a unified informational algorithm.

The fusion algorithm is an algorithm, whether similar or different algorithms, is merged with other algorithms having different embedded intrinsic characteristics in response to the correlation, interoperability and interactivity, thereby creating and a variety of information and performing the same.

The BAC generated by the activate algorithm and the fusion algorithm generated in the AOP 42 is an algorithm synthesis technology in which various data derived from IoE devices is merged with virtual reality such that actual reality and the virtual reality are implemented in the same manner to be connected and linked through an IoE device in operating and using the virtual reality in an environment in which the IoE is merged.

As shown in FIG. 4, the BAC is such that a number of activate algorithms generated in the eight algorithm areas are merged to form a fusion algorithm and by the fusion algorithm, all of the eight algorithm areas are synthesized and interconverted.

The BAC generated in the AOP 42 is such that biometric algorithms of a person which are derived from IoE devices (wearables, smart watches, smart bands, IoE sensors, smart glass, etc.) in which the LOVE-browser 20 is operated are synthesized to interact with physical algorithms such as virtual reality operating algorithms (spatial images, things, users, business objects, IoE sensors, etc.), thereby being compatibly linked with users (business entities) using the Live-BP 80 and IoE devices configured and operated in the Live-BP 80.

Due to the BAC generated and synthesized in the AOP 42, interconverting is performed such that the implementation of business forms, IoE operation, communities, visual and tactile, spatial images may be achieved in the Live-BP 80 in which environment objects (things, space, systems, IoE sensors, etc.) operated in the Live-BP 80 and users interact with each other.

The method for interconverting biometric functional algorithms of the BAC which have been generated in the AOP 42 is such that, in order to allow a smooth compatible linkage with biometric related algorithm, the associative properties of an algorithm is calculated to extract algorithms conforming algorithm DNS, thereby generating a single algorithm by algorithm formula operation to achieve compatibility.

According to an embodiment of the present invention, in order to have compatibility with various information introduced through the Live-BP 80 and the LOVE-browser 20 due to the synthesis of algorithm in the AOP 42, algorithms introduced from the ADT 41 are divided into eight algorithm areas to generate an activate algorithm, and due to the activate algorithm, a fusion algorithm is generated, and due to the fusion algorithm, the BAC (Bioactive Algorithm Compound) synthesizing and interconverting all algorithms are formed.

A step is included in which, due to the Bioactive Algorithm Compound (BAC) generated in the AOP 42, an algorithm algorithm-optimized for operating the Live-BP 80 is automatically sent to the optimal OAL (Optimization Algorithm Linkage) 43.

The OAL (Optimization Algorithm Linkage) 43 becomes a source from which all the algorithm-optimized algorithms may configure and use the Live-BP 80 in the AOP 42. The OAL (Optimization Algorithm Linkage) 43 is an optimization algorithm linkage which supports to be compatibly linked with the IoE-LDRT 50 in order to implement the 4D (feel, touch, emotions, etc.) which is capable of implementing five senses, such as touch, for environments and things constituting the Live-BP 80, and sends algorithms optimized in the AOP 42 to the VROM 60 in order to configure platforms for operating the Live-BP 80.

The OAL 43 is a step in which, when a user uses the Live-BP 80, an algorithm which requires the implementation of 4D by biometric activity on a platform configured in the VROM 60 is sent to the IoE-LDRT 50 and an algorithm which does not require the implementation of 4D in a process in which an actual real world and the Live-BP 80 are linked to interact is sent to the VROM 60, and algorithms are optimized and supplied to the IoE-LDRT 50 and the VROM 60 as needed.

According to an embodiment of the present invention, users and all objects using the Live-BP are designed to implement feel, touch, emotions, and the like that are felt in an interaction with users, all objects, virtual reality environments, things, and the like implemented in the Live-BP 80. It is a step of creating an environment to be compatibly linked with the IoE-LDRT 50 in order to operate the Live-BP 80 and implement 4D.

The OAL 43 is a step of generating a bio algorithm such that an algorithm (fusion algorithm, BAC) synthesized and generated in the AOP 42 to be compatible with the IoE-LDRT 50 is compatibly linked with the IoE-LDRT 50 configured to implement 4D. The Bio-algorithm is an algorithm in which the BAC, which is a fusion algorithm generated in the AOP 42, is transformed into a single algorithm and used in response to users, physical things, environments and the like who use the Live-BP 80.

In addition, the OAL 43 is a step of generating a bio-algorithm to be compatible and linked with the IoE-LDRT 50 in order to implement 4D (senses, feel, emotions, etc.) in the Live-BP 80.

A step is included in which algorithms derived from IoE devices to react by interaction with biometric algorithms related to a person which are compatibly linked in the OAL 43 are sent to the IoE-LDRT 50 in order to implement 4D, thereby linked to the IoE-LDRT 50 without algorithm errors.

In addition, the OAL 43 includes a step of directly sending algorithms to the VROM 60, the algorithms not related the 4D implementation, except for algorithms that should interact with the biometric algorithms which are sent to the IoE-LDRT 50.

Referring to FIG. 1, the IoE-LDRT (IoE-Live Data Relation Tool) 50 shown in FIG. 1 is a step of implementing status changes to human emotions and feelings and touch, senses and the like of things and environments to send algorithms introduced from the OAL 43 to the VROM 60 to be utilized in the Live-BP 80.

The IoE-LDRT 50 is a step of implementing, in an environment in which the IoE is merged, touch, feel, human emotions and the like generated by interaction of a third algorithm (IoE objects, spatial configuration algorithms, business entities, things, and the lie) related to a user's biometric algorithm according to the ultra-real time change of state in the Live-BP 80 and in an actual real world.

The implementation medium of the touch, feel, human emotions and the like is an IoE device (smart watch, wearable, smart band, IoE sensor, etc.) and inter-transmission is performed in ultra-real time.

In addition, due to the IoE-LDRT 50, emotion expression and business communication among users using the Live-BP 80 may be performed in various ways, so that it is possible to implement and experience the same daily life environment as in the actual reality.

It is a step in which algorithms implemented with 4D in the IoE-LDRT 50 are delivered to the VROM 60, and due to the IoE-LDRT 50, users using the Live-BP 80 implement touch, feel or the like of things and environments such as a spatial environment implemented in platforms configured in the Live-BP 80.

The Implementation method of 4D which is implemented due to the IoE-LDRT 50 is such that when users who use the Live-BP 80 input information of a wearable used in the real world to 4DID, which is a component of the LOVE-browser 20, a wearable compatible code WCC generated is introduced into the IoE-LDRT 50, and in the IoE-LDRT 50, a compatible code of the wearable device used in the real world to which the wearable compatible code WCC has been given is matched with an interaction target in the IoE-LDRT 50, so that feel for all the actions of the user in the Live-BP 80 may be felt in the real world via the wearable.

As a result, when using the Live-BP 80 via a wearable, 4D (sense, feel, etc.) is implemented at the moment of touch or contact with an object space and the like which are implemented in the Live-BP 80, so that it is possible to experience the 4D in the real world via a wearable.

A conventional LDRT may implement 4D only on a predetermined 4D configuration device. However, in an embodiment of the present invention, due to bio-algorithms generated in the VR-AS 40 compatible with the IoE-LDRT 50, 4D may be implemented on various types of wearables (smart watches, smart bands, smart sensors worn by a human body, etc.) in which the LOVE-browser 20 is operated and which can be worn on a human body.

Among algorithms introduced from the OAL 43, biometric algorithms for human, IoE device-derived algorithms that need to react with the biometric algorithms by interaction, algorithms such as space, environment, and objects constituting virtual reality are introduced into the IoE-LDRT 50 to implement 4D (senses, touch, feel, emotions, etc.) via a wearable.

A step is included in which algorithms which have been subjected to algorithm processing for implementing 4D in the IoE-LDRT 50 are sent to the VROM 60 to configure platforms operated in the Live-BP 80.

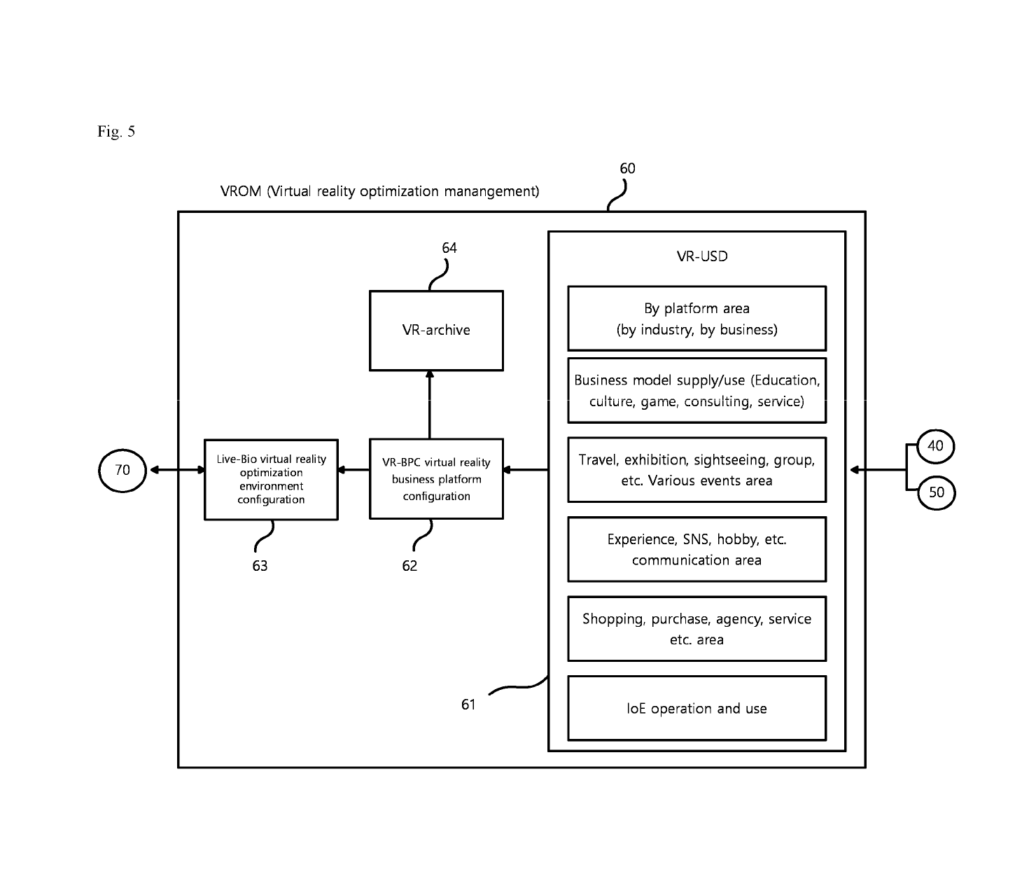

FIG. 5 is a view showing the configuration of the VROM 60 according to an embodiment of the present invention.

The VROM (Virtual Reality Optimization Management) 60 is a virtual reality optimization management which, based on algorithms introduced from the OAL 43 and the IoE-LDRT 50, builds and manages a virtual reality environment and a business platform that are optimized for operating the Live-BP 80.

According to an embodiment of the present invention, the VROM 60 is a step of configuring various platforms to be operated in the Live-BP 80 according to user's usage environment, usage purpose, user's tendency, business type, daily life and the like, in operating the Live-BP 80.

In addition, the VROM 60 is a step of creating an environment in which an object (space, thing, device, sensor, system, etc.) operated and configured in the Live-BP 80 and a user interact with each other smoothly and which is optimized for operating a business and the Live-BP 80 so as to provide a variety of virtual reality platforms and data and configuring various industrial platforms to be operated in the Live-BP 80.

According to an embodiment of the present invention, the optimization processing of the VROM 60 is performed by configuring and providing various life-identical daily life type platforms and various business platforms to be operated in the Live-BP 80 and allowing the IoE to be operated in the configured platforms, thereby linking algorithms introduced from the OAL 43 and the IoE-LDRT 50 with an actual real world to be operated.

The optimization operation is performed such that users, corporations, business entities, IoE devices, IoE objects and the like that operate and use the various business platforms configured above have the same life, businesses and the like as in daily life in the actual real world.

In addition, by performing the optimization above, the VROM 60 establishes sorting and standardization of virtual reality operations for the operation of the Live-BP 80, thereby establishing a strategic direction to promote optimized virtual reality business activities and life-identical virtual reality, and based on algorithms optimized in the OAL 43 and the IoE-LDRT 50, configures many different types of platforms to be variously utilized.

Conventional virtual reality operates only a unified virtual reality operation area, thereby providing unified service and limited experience, and has a limitation in implementing various platforms and providing various services.

In addition, conventionally, there is no virtual reality which implements and operates the IoE in a virtual reality environment in which the IoE is merged.

According to an aspect of the present invention, such a limitation may be overcome due to the VROM 60, and it is possible to configure various virtual reality platforms linked with an actual real world, provide various services, and operate the life-identical virtual reality business platform (Live-BP) which can operate the IoE by merging the IoE in virtual reality. As a result, various business platforms are configured and operated in the Live-BP 80 allowing various business services to be used, and it is possible to configure a virtual reality business platform which is linked to a real world, thereby allowing living the same like, and which is capable of simultaneously link and operate a virtual reality and a real world through the IoE.

Virtual reality business platforms optimized and configured in the VROM 60 as described above are sent to the Live-BP 80, so that various platforms are operated in the Live-BP 80, and every daily life activities and businesses are performed in virtual reality linked with actual reality as a life in an actual real world.

Referring to FIG. 5, the configuration of the VROM 50 is configured by including aVR-USD 61, aVR-BPC 62, a Live-Bio 63, and a VR-archive 64.

The VR-USD (Virtual Reality-Use Scope Distinction) 61 is a step of, based on algorithms introduced from the IoE-LDRT 43 and the OAL 50, classifying an algorithm that corresponds to a usage area of a platform configured and operated in the Live-BP 80 according to the purpose of use.

As shown in FIG. 5, the VR-USD 61 automatically classifies a platform to be used and operated according to the usage and purpose of use/operation by a user/operator of the Live-BP 80 into six platform configuration areas [(Platform area—by industry, by business), (IoE operation area), (Business model supply/use area-education, culture, game, consulting, service, distribution, etc.), (Various events areas such as travel, exhibition, sightseeing, group, etc.), (Experience, SNS, hobby, communication area), (Shopping, purchase, agency, service area)].

According to an embodiment of the present invention, due to an IAI which is a technology of classifying into 6 algorithm areas in the VR-USD 61, all the algorithms of the VR-USD 61 are automatically classified by each area.

In the above, the IAI (IoE Algorithm Interpretation), a technology of automatically classifying into 6 algorithm areas, combines and analyzes algorithms of each category area to set up and generate a suitable are for configuring a platform. In addition, the IAI finds the same information communication algorithm as the user terminal 10 using the LOVE-browser 20 to enable information communication in platform configured in a corresponding algorithm area.

Due to the IAI, the IoE and virtual reality are merged to operate the Live-BP 80, and the IAI is a fundamental step for configuring various platforms in the Live-BP 80 and allowing various business activities to be performed therein.

The VR-USD 61 is a base step of configuring various platforms to be operated and used in the Live-BP 80, and includes a step of sending the six algorithm areas classified in the VR-USD 61 to the VR-BPC 62 to configure a virtual reality business platform.

The VR-BPC (Virtual Reality-Business Platform Composition) 62 is a virtual reality business platform configuration step of configuring a platform that allows a platform to be freely configured according the configuration of a platform according to the six algorithm areas introduced from the VR-USD 61, the application purpose and usage of a user and an operator.

The VR-BPC 62 is a technical step that allows a virtual reality platform to be freely set up and configured according to the 6 algorithm areas classified in the VR-USD 61 in order to meet the usage purpose of a user who uses the Live-BP 80.

In addition, the VR-BPC 62 is a step of configuring various life-identical platforms closely related to daily life of an actual real world to be used in the actual real world and in the Live-BP simultaneously, by being compatible with all the platforms operated in the actual real world.

In the above, due to a VR-MPM (Virtual Reality-Multi Platform Module) enabling a platform operated in the Live-BP to be compatibly linked with all the platforms formed in real life, compatible linkage to all the platforms operated in the real world is achieved.

By allowing the configuration of a platform implemented in the VR-BPC 62 to conform the environment of a platform to be operated and compatible in the Live-BP 80 and establishing the sorting and standardization of the platform for the operation and use of the Live-BP 80, the transition to various platforms according to the application purpose and purpose of use is automatically performed, and various virtual reality business platforms are configured by operation area.

Since conventional virtual reality platforms are different for each device and operating system and operates only one platform on a closed platform, the compatibility between individual virtual reality systems is low and there is a limitation in using and operating the IoE.

According to an embodiment of the present invention, with the invention of the VR-BPC 62, it is possible to operate the Live-BP 80 capable of configuring various life-identical platforms and operating and using the various platforms simultaneously.

Due to the VR-MPM, a platform compatible operating technology executed on the VR-BPC 62, various virtual reality platforms are configured and optimized according to the application usage of a user, so that it is possible to configure and operate a life-identical virtual reality platform to be utilized in daily life in real life.

The VR-MPM, which is executed when the platform is configured in the VR-BPC 62, connects not only data about a virtual reality business platform but also IoE objects such as things, space, IoE sensors, systems, and IoE devices, thereby allowing a platform to be operated, which has become intelligent by exchanging information with a virtual reality and a real world.

In addition, the VR-MPM is a virtual reality platform conversion technology which automatically converts algorithms classified in the VR-USD 61 to data constituting a virtual reality platform, and is a virtual reality platform conversion technology based on elements which sharply increase data, such as IoE devices, SNS media, mobiles, Webs, cloud services and the like.

As a result, various platforms operated in the Live-BP 80 are linked with virtual reality and an actual real world and operated.

In addition, in conventional virtual reality, platforms are incompatible with each other because the development method and operation method thereof are different, and there is a limit in configuring and operating a plurality of platforms in one system. According to an embodiment of the present invention, due to the VR-MPM which is executed when the platform is configured in the VR-BPC 62, in order to overcome the limitations and operate and use various virtual reality platforms, it is possible to operate and use various virtual reality platforms to be simultaneously linked to actual reality and virtual reality by being compatible with platforms which are different therefrom and the conversion of data.

The VR-BPC 62, based on the algorithm areas classified in the VR-USD 61, configures a life-identical virtual reality platform that is optimized for the application usage and purpose of a user, sends data to the Live-Bio 63 to create an environment optimized for the configured platform, and sends mass data and data for the storage and management of platforms to the VR-Archive 64.

The Live-Bio (Life identical Virtual Reality-Business Implementation Optimization) 63 is a step of creating a virtual reality environment optimized for the environment of a user and an operator of virtual reality business platforms in which various life-identical platforms configured in the VP-BPC 62 are introduced therefrom, and providing an optimized life-identical virtual reality business platform (Live-BP 80) environment in which the same life and businesses as in an actual real may be performed.

The Live-Bio 63 is a step in which a platform configured in the VR-BPC 62 and all operation objects, users, IoE devices and the like operated in an actual real world are integrated, and to allow such integrated environment to be utilized in a virtual reality business and a real world environment, a compatible environment between the actual real world and virtual reality is configured.

Due to the configuration of the compatible environment, connection to all the objects in a real environment of people (users) using the Live-BP 80 is achieved for interaction, and connection to all the objects of the Live-BP 80 is achieved for interaction, so that the real world and the virtual reality world are operated in the same manner to create an environment in which everything of the real world is managed in virtual reality.

According to an embodiment of the present invention, the Live-Bio 63 is a technology embodying virtual reality by the interaction between the Live-BP 80, people of an actual real world, and people and objects implemented in a virtual reality world, and provides an optimal environment and a new platform environment by an optimization processing enabling the virtual reality world to manipulate the actual real world.

In addition, the Live-Bio 63 designs an interface in consideration of various user terminal 10 environments of users who use the Live-BP 80 to create an environment which enables the linkage of services provided from a system and a platform which are linked when using the Live-BP 80.

In addition, in the above, a life-identical virtual reality optimized environment is configured in which business entities, things, and space of an actual real world interact with objects of a virtual reality world to embody the Live-BP 80 as an actual real world experience, so that through providing surrounding environment information suitable for behavioral motions based on user preferences and circumstances, the user may freely link the Live-BP 80 with the actual real world.

A step is included in which platforms with platform environments optimized in the Live-Bio 63 are sent to the Live-BPPM 70 to be operated in the Live-BP 80.

The VR-Archive 64 is a step of managing and loading various platform information and virtual reality data configured in the VR-BPC 62, and extracting and supplying the platform information according to the request of a user when data is required.

In addition, via the user terminal 10 in which the LOVE-browser 20 is operated, a user may store, confirm, and delete platform use information such as user's personal information and platform use history according to the use of the Live-BP 80, anytime and anywhere.

The VR-Archive 64 is a virtual reality platform information management space which backs up platform information used and operated in the Live-BP 80 and large spatial image data of virtual reality operation to allow the same to be stored easily and quickly and shared easily, thereby managing, storing, and disposing the information of users and businesses.

In addition, the VR-Archive (64) is capable of automatically discard and reset spatial image data or s business platform that is not used for a predetermined period of time in the Live-BP 80, so that a platform operator may provide secure data protection and a backup system while providing a virtual reality environment.

The VR-Archive (64) is designed based on an expandable structure to support large databases, maximizes compatibility with other systems' databases, performs ultra-high volume integration data processing to overcome the limitations of data processing performance, and maintains the scalability of data to load and manage data optimized for various business platform environments.

When a user sends and receives data to request confirmation, deletion, and correction of personal information and virtual reality use information used in the Live-BP 80 through the user terminal 10 in which the LOVE-browser is operated, the VR-Archive 64 includes a step of sending the data to the VR-BPC 62 to be fed back to the user terminal 10.

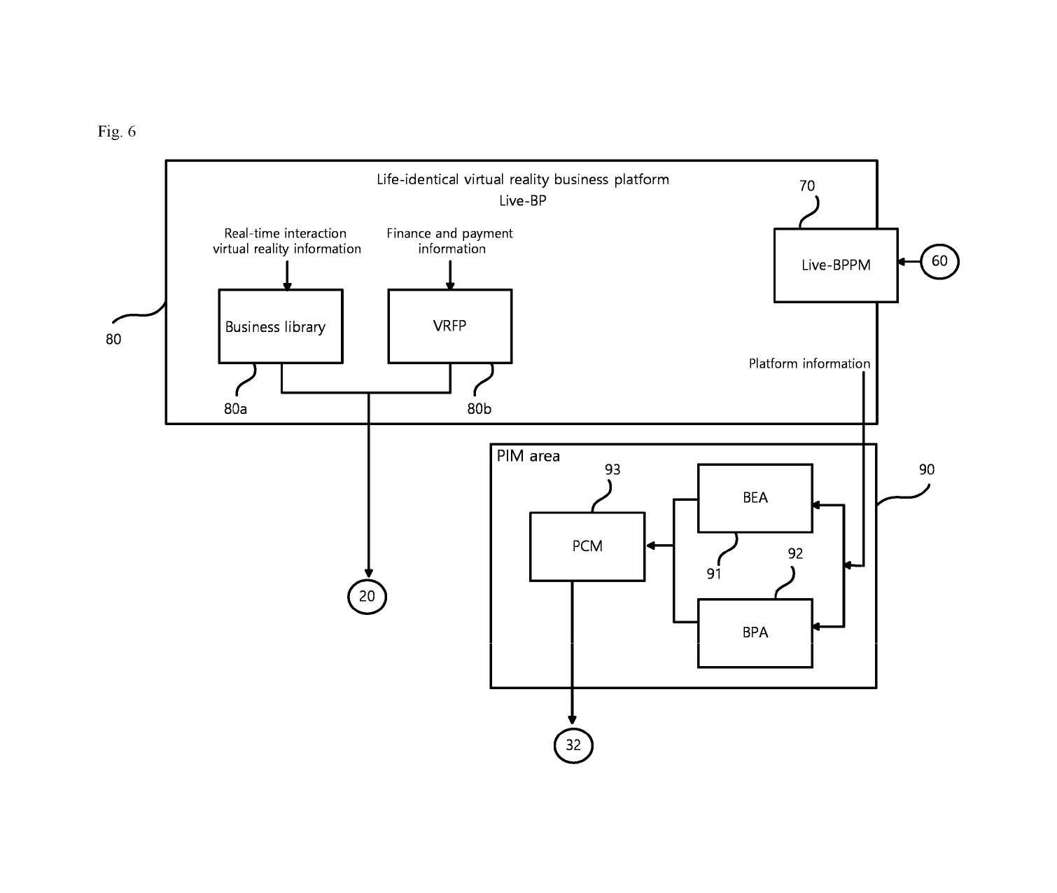

Referring to FIG. 6, the Live-BPPM (Life identical Virtual Reality-Business Platform Practice Module) 70 shown in FIG. 6, is an execution module of the life-identical virtual reality business platform Live-BP 80 that allows platforms created optimally for the operation of the Live-BP 80 in the Live-Bio 63 and users using the Live-BP 80 to execute the Live-BP 80 stably.

The Live-BPPM 70 is a virtual reality execution module which allows, when users using an optimized platform and the Live-BP 80 uses the Live-BP 80 in the Live-Bio 63, an integrated operation of the IoE operation and an identification system (IoE devices, IoE sensors, etc.) so as to operate and use the Live-BP 80 through free information communication between various heterogeneous systems and the user terminal 10.

In addition, the Live-BPPM 70 secures compatibility for a stable linkage between actual reality and the Live-BP 80 which are linked via the user terminal 10 by the integration of various platform interfaces configured in the VROM 60. In addition, the Live-BPPM 70 is a step of providing the linkage between a structure and an interface that guarantee the diversification of platforms operated in the Live-BP 80 and the scalability of virtual reality functions, and the operability that guarantees the sequential processing of platforms operated in the Live-BP 80 such that platforms operated in the Live-BP 80 are operated smoothly.

In addition, the Live-BBPM 70 is a step of guaranteeing the operability of the Live-BP 80 to allow users to use the same stably.

Due to the Live-BPPM 70, the Live-BP 80 may be stably operated.

FIG. 6 is a view showing the life-identical virtual reality business platform (Live-BP) 80 according to an embodiment of the present invention.

Referring to FIG. 6, the Live-BP 80 and the PIM 90 according to an embodiment of the present invention will be described.

The Life-BP (Life identical Virtual Reality-Business Platform) 80 is a life-identical virtual reality in which various platforms optimized and configured in the VROM are executed by the Live-BPPM 70 to allow users using the user terminal 10 in which the LOVE-browser 20 is operated and the IoE devices to execute a virtual reality business which is the same as in daily life anytime and anywhere and to provide convenience services of daily life.

According to an embodiment of the present invention, the Live-BP 80 implements a living environment of actual reality in which the IoE is operated exactly the same in virtual space, and connects and links IoE devices and information communication terminals operated therein to the user terminal 10, the Live-BP 80 and a real world to configure platforms generated in every industry of the real world the same way in a virtual reality space so as to be operated and used as in reality.

In addition, the Live-BP 80 allows a user using the user terminal 10 in which the LOVE-browser is operated to freely participate in the Live-BP 80 so that a user and a business, a business and a business, a user and a user, a user/business and an IoE device, and IoE device and an IoE device share by information communication by interaction. It is life-identical virtual reality in which, due to voluntary participation of the public in the Live-BP 80, various virtual reality platforms are created by the public, and the distribution of platforms is supported such that daily convenience services and business models of the public which are operated in the platform created above are operated smoothly.

Conventional virtual reality is capable of implementing an actual real space and implements an actual person in virtual reality to perform a unified experience and a business, but has a limitation in integrating and utilizing the Internet of Everything (IoE) in the virtual reality to operate a life-identical virtual reality which is the same as real life.

According to an embodiment of the present invention, in order to overcome the limitation of conventional virtual reality, the Live-BP 80 has been invented to operate a life-identical virtual reality in which an actual real spatial background in which the IoE is merged and operated, a real person who uses the IoE, and an IoE device used by the user are simultaneously implemented to allow the same life as in an actual real situation.

In addition, use entities (users, businesses, IoE devices, and IoE sensors) of a platform who use various platforms configured in the Live-BP 80 interact with each other to be intercompatibly linked not only with a business but also with IoE devices, IoE sensors, and wearables operated in platforms configured in Live-BP 80, so that reality is linked in virtual reality to operate the IoE and lead every activity of daily life such as a business.

The IoE information formed in the life-identical reality environment implemented above is communicated, through the user terminal 10 which uses the LOVE-browser 20, with IoE devices, IoE sensors, wearables and the like of an actual real world, so that when an IoE device is operated in Live-BP 80, an IoE device in an actual real life is also connected and linked.

In addition, through an IoE device or the user terminal 10 implemented and operated in the Live-BP 80 by the user terminal 10 or an IoE device operated in an actual real world, the Live-BP 80 communicates with an IoE device present anywhere regardless of the difference of space, environment, people, and culture to configure various platforms throughout the society, culture, economy, industry and the like to which all the platforms of the actual real world are applied, and anyone may operate platforms through the user terminal 10 in which the LOVE-browser 20 is operated.

The Live-BP 80 implemented according to an embodiment of the present invention will be described as follows.

User A accesses the Live-BP 80 through the user terminal 10 in which the LOVE-browser 20, which is an information communication medium means, is operated.

The Live-BP implements an actual real environment having an actual person, a spatial background or an environment as in an actual life. An IoE device, an IoE sensor, a wearable and the like are configured and operated therein, so that the user A may communicate information through the IoE device in the Live-BP 80.

In addition, the user A operates the IoE through an IoE device operated in an environment of a real person and an actual real world implemented as described above, so that the IoE is operated in the actual real world and IoE services are given.

In addition, all of the businesses taking place in Live-BP 80 are linked and operated in an actual real world so that the same business activities are performed in reality and in virtual reality.

In addition, due to various platforms configured in the Live-BP 80, the user A may participate in a platform operated in the Live-BP 80 to conduct a business, and in the Live-BP 80, the user A may freely open a platform and operate the platform.

As in the embodiment above, the Live-BP 80 simultaneously connects a virtual space and a real world in real time and compatibly links the same though an IoE device implemented and operated in a virtual reality space in order to experience virtual reality by interaction and operates an IoE device in a real world, receives IoE services and conduct activities of daily life through the virtual reality.

In addition, as in the above embodiment, the Live-BP 80 merges and operates the IoE to establish a close relationship with an actual real life.

It is a virtual reality business platform in which all the objects in the Live-BP 80 are interacted with a physical space which a user may actually experience so as to exchange information, thereby operating the IoE.

In addition, the Live-BP (80) operates various platforms in an environment in which the IoE is merged and implemented, thereby providing information optimized for a user context to a real world.

The optimized information described above is such that an IoE communication infrastructure for connecting data analysis requested by users, living convenience services necessary for users and business objects and the like in real time is easily implemented, so that a life-identical virtual reality platform is naturally and not uncomfortably provided, which provides various services and information that may be conveniently used.

According to an embodiment of the present invention, in order to effectively manage IoE terminals and sensors used by connecting and linking the Live-BP 80 and a real world, a VR-IDM (Virtual Reality-IoE Device Manager) which is a virtual reality IoE device management system that is capable of establishing a full-cycle relationship system assigns a unique identification number to an IoE device operated and used in the Live-BP 80 and manages the same.

Since the entire life-cycle of IoE devices, sensors, IoE devices and the like may be managed through the Live-BP 80 due to the VR-IDM, by utilizing the user terminal 10 in which the LOVE-browser 20 is operated, an IoE device of a real world may be operated and manged in the Live-BP 80.

Conventionally, there has been no standard regarding an IoE terminal identification system and production, an information standardization scheme of disposal, and the like, so that there has been a limitation in managing IoE devices.

According to an embodiment of the present invention, a step is included in which due to history management by the Live-BP 80 of IoE devices operated in the Live-BP 80, the limitation of IoE device management is overcome and an information identification system of the IoE devices operated and used in the Live-BP 80 is provided.

The VR-IDM enables an effective IOE device management and supports to easily identify information of a corresponding device from the first use of the device.

In addition, the conventional virtual reality has a limitation in going beyond unified virtual reality that is implemented with a virtual reality operation device such as PCs, smart phones, HMDs, and the like and implementing a virtual reality world which is capable of interacting with five senses, such as touch, by human biological effects in various devices in an environment in which the IoE is merged.

According to an embodiment of the present invention, the Live-BP 80 overcomes the limitations and may operate and use virtual reality interacting with human five senses anytime and anywhere only if the LOVE-browser 20 is operated in the user terminal 10.

As a result, performance good enough for enabling all users to easily use the Live-BP 80 is secured, and a new virtual reality market is formed which creates a life-identical virtual reality ecosystem in which new virtual reality and the IoE are merged.

The Live-BP 80 is capable of configuring a necessary platform according to the six virtual reality platform configuration areas classified in the VR-USD 61, so that any user who uses the Live-BP 80 via the LOVE-browser 20 may freely operate and use life-identical services and business models operated in a platform.

As a result, the Live-BP 80 implements a reality-corresponding virtual reality that operates a real world in virtual reality, thereby operating a life-identical virtual reality that goes beyond technology and cost limitations to create a new virtual reality business platform ecosystem.

When a platform is configured in the Live-BP 80 based on a platform of some of the six virtual reality platform configuration areas and applied to a space or an environment to be configured and managed, it is possible to identify temperature or humidity, various equipment conditions, energy usage, and the like at once. A life-identical factory is executed, which is capable of controlling a workspace or an environment of a real world in virtual reality via the Live-BP 80, a virtual reality space, without having to go to a site.

Due to the life-identical factory, when the Live-BP 80 is applied to various industry areas such as production, manufacturing, and the like, there is no need to install a separate storage device or information processing system, and the Live-BP 80 is life-identical virtual reality capable of effectively operating an industry without investing in a high-cost development.

In addition, since the Live-BP 80 is a life-identical virtual reality in which many people may freely participate and lead daily life, a platform operated in the Live-BP 80 and a distribution channel inside the platform are integrated to provide various shopping platform environments.

As a result, the Live-BP 80 may provide information optimized for consumers' situations in real time and space in which consumers' actual lives take place, and it is virtual reality that naturally induces purchase and distribution.

According to an embodiment of the present invention, the Live-BP 80 may configure a financial-related platform in virtual reality, and with the merge of finance, may perform financial affairs of a real world in virtual reality and provide convenient and differentiated virtual reality financial services.

Financial services operated in an actual real world may be linked and operated in various business platforms operated in the Live-BP 80, and users who use the Live-BP 80 via the LOVE-browser 20 in the above linked and operated environment may perform financial transactions anytime and anywhere by linking the Live-BP 80 and the actual real world simultaneously. By connecting and operating virtual reality and a financial system of a real world, business models are diversified, and by accurately identifying financial consumers' needs, appropriate financial services are supplied and operated, and thus, in an environment in which the IoE is merged, a new financial ecosystem connecting and linking virtual reality and a real world is formed.

A financial service operated in the Live-BP 80 which is implemented according to an embodiment of the present invention will be described as follows.

User A uses a financial platform operated in the Live-BP 80 via the user terminal 10 in which the LOVE-browser 20 is operated.

The user A's IoE device or user terminal 10 registered in the LOVE-browser 20 used by user A are linked to IoE devices and financial systems of banks and financial institutions to perform information communication, so that the moment the user A enters a bank or a financial institution which is identically implemented as in reality in the Live-BP 80 used by the user A, an actual bank employee will prepare necessary details, such as account information. The user A may also use his/her own IoE device and the user terminal 10 to perform financial transactions.

The user A may be consulted anytime, anywhere through the Live-BP 80 as if he/she is at a financial institution store, and by operating IoE devices, virtual reality banking is performed with a high banking response rate.

As in the embodiment above, all financial affairs may be linked to the real world via the Live-BP 80 to execute financial business.

According to an embodiment of the present invention, information generated in IoE sensors operated in the Live-BP 80 and information generated in IoE sensors of an actual real world connected and linked to the Live-BP 80 are shown in detail on the user terminal 10 in real time through the VRFP 80B when users request.

There has been a limitation in which the distribution of platforms, business models, and virtual reality services provided in conventional virtual reality was not smoothly performed.

It has not been easy to build and operate a platform in a situation in which the distribution of platforms was monopolized by a specific company. In addition, a conventional virtual reality platform was a unified service platform and the number of users using the virtual reality was limited, and platforms and service standards provided for each virtual reality operation device were all different, so that there was a limitation in using various platforms with one device.

According to an embodiment of the present invention, the Live-BP 80 overcomes the limitations and allows everyone to configure and use a number of various platforms.

The Live-BP 80 is life-identical virtual reality in which a provider and a user of a platform simultaneously link virtual reality and an actual real world, thereby, by an organic connection, providing a stable open platform which users can trust.

The operation of the Live-BP 80 is transmitted to the LOVE-browser 20 through a business library which is a component of the Live-BP 80 and real-time feedback with a user is performed through the user terminal 10, so that life-identical virtual reality in which an actual real life is performed is operated and used.

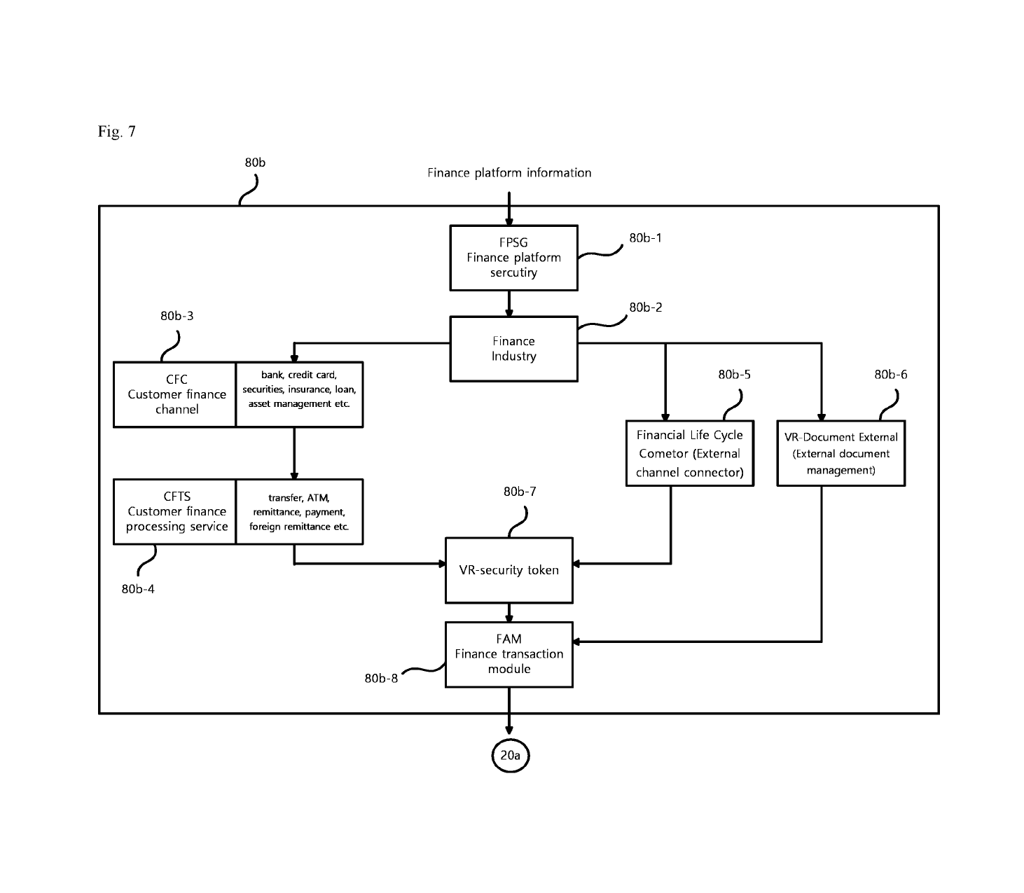

Referring to FIG. 6, as shown in FIG. 6, the Live-BP 80 according to an embodiment of the present invention is configured by including a business library 80A and a VRFP 80B, and the VRFP 80B is described with reference to FIG. 7 in detail.

The business library 80A is a connection path for all information generated in the Live-BP 80, the information which is delivered to the user terminal 10 through the LOVE-browser 20 in real time and fed back to the Live-BP 80 for information communication by all users and business entities, IoE objects and the like according to the use of all platforms performed in the Live-BP 80 and operation of a user who is engaged in and experiences everyday life.

In addition, the business library 80A is an information communication path which supports all business entities (users, IoE objects, platform operators, etc.) and the like that are active in the Live-BP 80 to be connected and linked with an information communication medium such as the user terminal 10 in order to be able to communicate with a business entity in an actual real world.

The information transmission method of the business library 80A is a circular information transmission method which is performed transmitting behavior motions of a user, a business entity and an IoE object taking place in the Live-BP 80 and responses of an information object operated in the Live-BP 80 by an information execution command via the user terminal 10 by a real-time response and an information command caused by the interaction with a real-world information object, and the IoE object delivers an execution result (information) of the Live-BP 80 to the LOVE-browser 20 in real time by an automatic information execution command system of the IoE object and a command and behavior motion of the user terminal 10.

In addition, a process is included in which when IoE-related information automatically recognized about IOE devices, IoE sensors, IoE objects, and the like which are operated in the LOVE-browser 20 needs to be communicated in real time with an IoE object in reality, the information is automatically delivered to the LOVE-browser 20, and thus, is delivered to the user terminal 10.

The business library 80A is a virtual reality information delivery medium in which all operational information of platforms configured in the Live-BP 80 is delivered to the LOVE-browser 20 according to the request of a user and an IoE object, and thus, is delivered the user terminal 10.

FIG. 7 is a view showing the VRFP 80B, which is a component of the Live-BP 80 according to an embodiment of the present invention.

Referring to FIG. 7, the VRFP 80B according to an embodiment of the present invention will be described.

The VRFP (Virtual Reality Finance Platform) 80B is a virtual reality financial platform in which all financial transactions taking place in the Live-BP 80 are connected and linked with a financial transaction system of an actual real life, so that financial affairs are processed by real-time business compatibility with a financial institution in the real world.

According to an embodiment of the present invention, a step is included in which the VRFP 80B supports financial transactions and electronic payment affairs taking place in all platforms configured and operated in the Live-BP 80, and processes financial affairs in virtual reality utilizing the user terminal 10 in an environment in which the IoE is merged.

It is a step in which, due to the VRFP 80B, financial transactions and electronic payments taking place in many various business platforms configured and used in the Live-BP 80 are integrated with real world financial institutions (banks, insurance companies, securities companies, investment institutions, PG companies, Fin-Tech companies, asset management, and Internet banks) and operated.

In addition, the VRFP 80B may combine various business platforms operated in the Live-BP 80 with various financial services operated in an actual real world, and in the combined environment, users using the Live-BP 80 through the LOVE-browser 20 are able to simultaneously link the Live-BP 80 with the actual real world to perform financial transactions (transfer, payment settlement, investment, asset management, loan, credit card, securities business, transfer, ATM, etc.) anytime and anywhere through the VRFP 80B.

Fin-Tech, a kind of conventional financial platform, refers to all services that provide new and convenient forms by combining financial services that are commonly used every day with IT technology. Since financial companies or Fin-Tech service providers that are spreading like fashion are entering into Fin-Tech business without a special and differentiated model, the business environment is becoming increasingly opaque, market saturation is becoming more severe and financial business models become unpredictable.

There is a demand for an innovative and popular financial model beyond a simple financial model that combines a simple Fin-Tech model with a fragmentary financial business model.

In addition, a conventional Fin-Tech business model is buried only in a payment business, and thus, has a limitation in operating a variety of popular financial business models.

According to an embodiment of the present invention, the VRFP 80B may overcome the above limitations and connect and link virtual reality with financial systems in the real world to diversity financial models, thereby accurately identifying the needs of financial consumers and establishing and operating an appropriate financial business.

Financial transactions and the like of a new financial ecosystem formed by various financial platforms formed by the above are transmitted to the LOVE-browser 20 in order to be linked to the off-line which is the real world, thereby being connected and linked with real financial institutions, financial systems, and Fin-Tech service companies.

It is a step in which a new financial paradigm is formed in which virtual reality and the real world merged with the IoE are simultaneously connected due to the above.

In addition, the VRFP 80B is a technical stage of a financial platform operation in which the flow and data of business entities associated with a financial-related business platform operated in the Live-BP 80 are analyzed to construct a new financial platform and a financial model.

Due to the VRFP 80B, financial transactions and financial affairs performed in a real world may be operated in the Live-BP 80 implemented in a virtual reality space, and through financial platforms implemented in virtual reality, financial transactions of an actual real world may be performed.

In addition, financial platforms operated in the Live-BP 80 may be freely created and utilized by anyone who uses the LOVE-browser 20, and therefore, the VRFP 80B is a step in which a new financial ecosystem is formed with the liberalization of financial platforms.

Referring to FIG. 7, the VRFP 80B is configured by including a FPSG 80B-1, a Finance Industry DB 80B-2, a CFC 80B-3, a CFTS 80B-4, a Finance Life Cycle connector 80B-5, a VR-Document External 80B-6, a VR-security token 80B-7), and a FAM 80B-8.

The FPSG (Finance Platform Secret Guard) 80B-1 is a financial platform security step in which financial-related information derived from the Live-BP 80 is introduced and security of financial information and safety of financial data are secured.

The FPSG 80b-1 has been designed to analyze financial and electronic payment-related data introduced from the Live-BP 80 in detail so as to effectively detect and block external attacks, thereby more easily and accurately recognizing, from the initial detection in a unified security management environment to all information flows throughout a financial platform network, so that detecting and identifying actions of an attacker that moves internal systems, such as which data is being sent or received by malicious code, thereby achieving dynamic security.

Conventionally, since many of IoE devices use embedded Linux as an operating system, there is a limitation in applying a malicious code blocking function and financial security system to the IoE devices in a Windows PC environment.

According to an embodiment of the present invention, due the FPSG 80B-1, a variety of security features such IoE security (authentication, key management), communication, network security, IoE Infrastructure security that are operated in the Live-BP 80 are provided.

A step is included in which data secured with the safety of financial data in the FPSG 80B-1 is sent to the FIDB 80B-2.

The FIDB (Finance Industry Data Base) 80B-2 is a step of, based on financial information verified for security and then introduced from the FPSG 80B-1, storing and managing overall financial industry information operated in the Live-BP 80 to classify and supply the information according to the type of financial business.

The FIDB 80B-2 includes a step in which data of all financial businesses taking place in the Live-BP 80 is stored and managed such that financial products and types used by a user are sent to the CFC 80B-3, data used by connecting existing financial transactions (financial transactions in an actual real world) and existing Fin-Tech services that are used by the user in the Live-BP 80 is sent to the Finance Life Cycle Connector 80B-5, and information related to electronic settlement documents operated by connecting and linking the Live-BP 80 and the actual real world is sent to the VR-Document External 80B-6.

The CFC (Customer Finance Channel) 80B-3 is a customer financial channel in which information introduced from the FIDB 80B-2 is classified according to financial products and types (bank, credit card, insurance, securities, payment/settlement, electronic money, foreign remittance, loan, asset management) used by a user, and according to the financial affairs processing for each financial type channel, is automatically sent to the CFTS 80B-4.

Due to the CFC 80B-3, a user may select and use a financial channel of a financial platform operated in the Live-BP 80, and the operation of the selected financial channel may be used by linking the Live-BP 80 with an actual real world.

The information of the CFC 80B-3 is sent to the CFTS 80B-4.

The CFTS (Customer Finance Transaction Service) 80B-4 is a customer financial transaction service in which, based on the information introduced from the CFC 80B-3, processing services by type of financial transaction according to users are classified and executed.

The CFTS 80B-4 is a step in which a user selects a financial channel when using a financial platform in the Live-BP 80 for financial business execution (financial processing), and in which, due to the CFTS 80B-4, a financial business taking place in the Live-BP 80 is implemented in the same manner in reality so that all financial transactions are performed. In the financial transactions (transfer, remittance, settlement, ATM service, overseas emittance service, payment/settlement, etc.) performed in the CFTS 80B-4, if a physical passbook is used, or an electronic wallet is created, and an old bank account of a user is registered therein, all financial transactions may be performed at a counter without a seal and a bankbook, and ATM deposit and withdrawal is possible. In addition, it is a step in which electronic commerce as well as regular account registration may be performed in a financial platform configured in the Live-BP 80.

In addition, it is a step of, due to the CFTS 80B-4, supporting global financial services based on a P2P platform without involvement of financial institutions in the operation of the financial platform configured in Live-BP 80, thereby supporting a P2P loan service, a P2P overseas remittance service, and a P2P-based digital money system (bit coin).

The financial service processing data of the CFTS 80B-4 is sent to the virtual reality security token 80B-7.

The Finance Life Cycle Connector 80B-5 is a step of compatibly connecting, based on the information unified in the FIDB 80B-2, financial transaction products (such as financial-related transactions and types) and services of an actual real world and existing Fin-Tech services (PayPal, Alipay, Kakao pay, etc.) so as to be utilized in the Live-BP 80.

In addition, the Finance Life Cycle Connector 80B-5 is a virtual reality financial transaction connector which allows a financial transaction used in reality and a financial transaction operated in the Live-BP 80 to be simultaneously performed, and allows transactions of virtual reality and an actual world to be linked with the user terminal 10.

The Finance Life Cycle Connector 80B-5 sends information to the VR-security token 80B-7 in order to compatibly operate external financial institution information with the Live-BP 80, and to integrate and operate the same with external channels (Korea Financial Telecommunications and Clearings Institute, PG companies, financial evaluation authentication institutions, electronic commerce systems, etc.).

According to an embodiment of the present invention, the Finance Life Cycle Connector 80B-5 is a financial platform connector in which financial transactions of an actual world of an environment merged with the IoE operated in the Live-BP 80 are integrated and operated, in which and real-world off-line financial transactions are performed with the user terminal 10.

Due to the Finance Life Cycle Connector 80B-5, all services performed in existing off-line financial institutions based on existing financial transactions are used in Live-BP 80, so that all the services of the financial institutions are performed in a real world and in a virtual reality world simultaneously without problems and financial infrastructure is built and operated due to a financial platform through the Live-BP 80. The information of the Finance Life Cycle Connector 80B-5 is sent to the VR-security token 80B-7.

The VR-Document External 80B-6 is a step in which electronic documents required for business affairs such as electronic payment documents, tax invoices, and electronic forms made in the Live-BP 80 are compatibly linked to a document system formed by business execution in a real world, so that the documents are supported in virtual reality to be simultaneously issued and used in the real world and in the Live-BP 80, and is a step of writing, creating, and view documents used in the Live-BP 80.

The VR-Document External 80B-6 is connected to an actual real world, an electronic commerce system, and a payment system and manages external documents of the actual real world and documents which may be written and viewed.

In addition, the VR-Document External 80B-6 is a step in which a user may write a document or view a document in the Live-BP 80, and search and specify only the desired pages and immediately read the pages out of a document having a predetermined pages of up to hundreds.

The VR-Document External (80b-6) allows a document to be viewed and written in a business platform operated by in the Live-BP 80, which is a virtual reality world, by being linked with a document system of a real world or an electronic payment system. As a result, document sharing is achieved between the actual real world and the Live-BP 80, and electronic payment systems, electronic tax invoices and the like may be performed in virtual reality.

The VR-Document External 80B-6 supports operating systems (OS) and devices operated in the actual real world to support multi-platforms and multi-devices, and thus, documents may be easily viewed in the Live-BP 80 in any environment.

A step is included in which the document information of the VR-Document External 80B-6 is sent to the Fam 80B-8.

The VR-security token 80B-7 is a financial transaction security authentication step for authenticating data introduced from the CFTS 80B-4 and the Finance Life Cycle Connector 80B-5.

According to an embodiment of the present invention, the VR-Security token 80B-7 has been invented since a way or means are required to present a user's unique information which can replace a user's identification as in off-line to identify a user in a non-facing environment such as a financial platform operated in the Live-BP 80, so that multiple user information is created and unique authentication information that is granted only to the user is provided and support is provided for comparison thereof to generate and operate authentication means.

The VR-security token 80B-7 is an electronic authentication means for identifying a user and identifying an IoE object, and is a virtual reality electronic authentication means that acts as an identification when financial transactions are conducted in an environment in which an actual real world and the Live-BP 80 are connected.

In addition, the VR-security token 80B-7 is designed to, in order to allow access to and use of financial systems of a real world for financial transactions used in the Live-BP 80, identify and authenticate a corresponding user, so that financial systems of an actual real world may be used in accordance with the authentication result in a way that is appropriate to the previously granted authority.

The VR-security token 80B-7 is a step of converting the financial-related information introduced from the CFTS 80B-4 into a password consisting of a random number and storing the password, thereby preventing leakage and illegal use of the financial information generated in the Live-BP 80, and identifying a user by comparing and matching with a changed password, thereby allowing financial transactions in the actual real world and the Live-BP 80.

The VR-security token 80B-7 compatibly links the Live-BP 80 and the actual real world, and authenticates user authentication objects (IoE devices, financial services, etc.) by its own lightweight encryption and algorithmic processing when performing financial transactions.

Since the lightweight encryption algorithm process in the VR-security token 80B-7 is limited in storage space, the VR-security token 80B-7 has been designed to generate a secure authentication key by a cryptographic operation of the size of data along with the speed thereof, thereby having high security authentication performance.

In addition, the VR-security token 80b-7 is applied with a bio-information recognition (biometrics) technology that integrates IoE components such as sensors, devices, communications, networks, and operational services working in a financial business platform operated in the Live-BP to support security authentication, so that when the LOVE-browser 20 is used, authentication methods of an authenticated face or an IoE device should simultaneously match to be approved, which is a new concept of the token-based authentication method used in the Live-BP 80.

As a result, the VR-security token 80B-7 determines whether or not human biometric authentication (fingerprints, irises, faces, etc.) derived from an IoE device used in a financial platform operated in the Live-BP 80 and security information generated by the lightweight encryption algorithm processing are matched to decide where to approve authentication of the financial transaction performed in the Live-BP 80.

A step is included in which only when security token information generated in the VR-security token 80B-7 and user authentication authenticated in the LOVE-browser 20 or IoE device authentication are simultaneously achieved, a financial transaction taking place in the Live-BP 80 is approved. The financial information authenticated in the VR-security token 80B-7 is sent to the Fam 80B-8.

The Fam (Finance account Module) 80B-8 is a financial transaction module which integrates information introduced from the VR-security token 80B-7 and information introduced from the VR-Document External 80B-6 to facilitate the financial transaction.

The Fam 80B-8 is a step of linking and operating the LOVE-browser 20 during a process in which a financial business taking place in the Live-BP 80 is performed through VRFP 80B, thereby connecting and operating a business transaction taking place in an actual real world in the Live-BP 80.

The Fam 80B-8 is compatibly connected to all operating systems of the user terminal 10 in which the LOVE-browser 20 is operated and supports multi-platforms and multi-devices, and is a module that not only Windows users, but also all mobile users, and users of IoE sensors, IoE devices and the like may easily connect and link in any environment.

In addition, since financial transactions taking place in a real world may be performed in the Live-BP 80 in the same manner via IoE devices, the Fam 80B-8 allows affairs such as inquiries, transfers, ATM transactions, payments and settlements, debit card use, credit cards, cryptocurrency, overseas remittance, electronic document payment to be interactively linked with banks, insurance companies, securities companies, Internet banks, Fin-Tech services, PG companies, and so on so as to be freely executed.

The information of the Fam 80B-8 is sent to the LOVE-browser 20, and thus, is transmitted to the user terminal 10, and after financial transactions connected to the Live-BP 80 is executed in a real world, is fed back to the Live-BP 80.

Referring to FIG. 5, the PIM 90 is configured by including a BEA 91, a BPA 92 and a PCM 93.

Referring to FIG. 6, the PIM 90 will be described.

The PIM (Platform Insights Management) 90 is platform insight management which inspects business platforms configured in the Live-BP 80 to collect and analyze morphological operational data, and thereby feeding business data to users using each platform and inspecting and managing a platform generated.

The PIM 90 collects business response and morphological information generated in the Live-BP 80 to provide information necessary for actual business management and businesses through the Live-BP 80, so that platform configurations and business strategies may be established, and platforms of an actual real world may be utilized.

In addition, the PIM 90 collects and analyzes the types and information of various platforms performed in the Live-BP 80, thereby supplying and sharing the same business data to users by sharing the platforms.

According to an aspect of the present invention, classification according to the form and operation of platform information taking place in Live-BP 80 due to the PIM 90 is performed by a BEA 91 (Business Biolysis Module).

The BBM (Business Ecology Module) is a business ecology module which, in analyzing and managing diverse and vast business data introduced from the Live-BP 80, classifies the data into ecological data and execution analytical data by the morphological characteristics of the data.

Ecological data of a business and data regarding the execution of a business which are classified by the BBM are sent to the BEA 91 and the BPA 92, respectively.

The BEA (Business Ecosystem Analysis) 91 is a business ecological analysis which analyzes and manages a business ecosystem based on business data derived from the Live-BP 80 and classified and received by BBM in order to inspect a business ecosystem taking place in the Live-BP 80.

The BEA 91 is a step in which not only the ecological information of a business operated in the Live-BP 80 and the keywords of SNSs (social network services) operated in the Live-BP 80 but also emotions of users (business entities) at the time of business execution are extracted and analyzed in order to derive associated properties.

In the above, when analyzing the business ecosystem, a method of ecological morphological analysis of the emotion extraction between a user and a business and the correlation between a business and a business includes a step in which a Business Biology algorithm, which analyzes the relationship between the emotion of a business entity and the business ecology at the time of business execution, is applied for analysis.

Due to the BEA 91, a wide range of information about platform operations and competitive platforms or competing product companies are provided, and in addition, the BEA 91 is a business ecological analysis step in which business ecological data derived from the Live-BP 80 is provided with various types of infographics and insight report services, thereby being used in an actual real world, and in which users intuitively understand reactions of consumers about business brands and products operated through a platform.

Due to the BEA 91, at the time of business execution in the Live-BP 80 and an actual real world, information is utilized for predictive analysis or future brand strategies and product development practices for each platform or customer. The above data is applied to various platform operations.

The BEA 91 accepts, inspects and manages various user environments taking place in the Live-BP 80.

In the above, the BEA 91 is a step in which a transaction application and a user-defined dashboard are provided to allow an operator who operates a platform in the Live-BP 80 to easily grasp the entire business flow. In addition, the correlation between business platforms formed in the Live-BP 80 and in a real world may be automatically linked to analyze transactions. From the creation of a platform in a virtual reality environment in which the Live-BP 80 and an actual real world are linked to the completion of a business in the Live-BP 80, transactional statistical data is provided as a lightweight numerical value to users and platform operators of the Live-BP 80, and various business platform applications performed in the Live-BP 80 are integrated and managed.

The BEA 91 supports the use of excellent navigation and visualization functions in various operating system environments of the user terminal 10 in which the LOVE-browser is operated, and expands peta-byte (PB) class data by real-time interaction support so as to be easily analyzed. Due to the expanded and enhanced in-memory performance, more platform data is processed in memories and cubes which are parallel partitions, and a business ecosystem is quickly analyzed.

Due to the BEA 91, the insight of a business taking place in the Live-BP 80 is secured, and business ecology information enhanced based on biometrics authentication and multi-factor authentication is provided to platform operators and users of the Live-BP 80 which is linked to an actual real world. The data analyzed in the BEA 91 is sent to the PCM 93.

The BPA (Business Practice Analysis) 92 is business execution analysis in which data derived from the Live-BP 80 and classified and introduced by the BBM is analyzed and managed for the implementation and operation of a platform in an actual real world.

The BPA 92 is a step in which, through business life cycle management which collects, analyzes and manages structured, unstructured, semi-structured data derived from the Live-BP 80 at the time of business execution, a platform operator of the Live-BP 80 is supported with technology and methods for solving internal compliance issues of a platform which is a business entity in various platforms.

In addition, the BPA 92 allows platforms or business entities operated in the Live-BP 80 to make various transactions occurring in real time as events to analyze a large amount of data not utilized in a real-world business, thereby increasing accuracy of various business affairs operated in the Live-BP 80 or in an actual real world. In addition, the BPA 92 proposes an efficient business execution through the analysis of business execution such as content state management, such as the event inference analysis, streaming analysis, and pattern analysis of a business taking place in the Live-BP 80.

According to an embodiment of the present invention, by the execution analysis of a business taking place in the Live-BP 80, the BPA 92 provides business information and business execution manuals optimized for users and business entities using the Live-BP 80, and by being linked with other platforms operated in a real world, provides users of the Live-BP 80 with business execution analysis information for securing flexibility between platforms and operating the platforms.

The BPA 92 operates a platform through the operation of a platform implemented in the Live-BP 80 and the IoE in which everything in life used by a user is connected to the Internet, and new IoE data is accumulated each time of use, and among the vast data, data related to business execution is analyzed and configured by 6 areas in the VROM 60, so that business execution information is transmitted to the platform operated in the Live-BP 80.

According to an embodiment of the invention, the BPA 92 is a step of blocking unnecessary information derived from an IOE device in an environment in which the IoE is operated and the Live-BP 80 and the actual real world are connected and linked to each other.

The Live-BP 80 is a virtual reality in which the public is free to participate, and the use of IoE devices for connecting and linking with a real world may rapidly increase. In using the Live-BP 80, if IoE devices are popularized, the stress caused by spam may become more intense and may interfere with business execution.

The BPA 92 is a step capable of solving the problem.

A method for solving the above problem includes analyzing in the BPA 92 the type of IoE device operation taking place in the Live-BP 80 and automatically recognizing and analyzing morphological patterns of users and business entities to block the inflow of unnecessary information, thereby managing information optimized for practical business execution and delivering the information to users of the Live-BP 80.

In addition, the BPA 92 is a virtual reality business execution analysis step of providing horizontal insight in which cooperation and information sharing between platforms executed in the Live-BP 80 and in an actual world are quickly deliver to where resources and information are scarce and needed.

A step is included in which the information of the BPA 92 is transmitted to the PCM 93.

The PCM (Platform Communication Module) 93 is a platform information delivery module which delivers data introduced from the BEA 91 and the BPA 92 to business entities and users using the Live-BP 80 and serves as a medium for the execution of businesses of the Live-BP 80 and of an actual real world through an organic connection and linkage for guidelines on the operation of a business platform.

In addition, the PCM 93 is a technical stage for integrated business execution of virtual reality and a real world in an environment in which the IoE is merged, and is an information delivery step for providing platform insight information suitable for various work environments.

The PCM 93 includes a step in which data derived from the BEA 91 and data derived from the BPA 92 are combined and sent to the Real-time Reporting 32, which is a component of the real-time interaction server 30, and thus, delivered to users of an actual real world and users and business entities of the Live-BP 80 via the user terminal 10 in which the LOVE-browser 20 is operated.

Although the present invention has been described with reference to a limited number of embodiments and drawings, it is to be understood that the present invention is not limited to the above embodiments. It will be understood by those of ordinary skill in the art to which the present invention pertains that various modifications and variations may be therefrom.

Therefore, the scope of the present invention should not be limited by the described embodiments, but should be determined by the scope of the appended claims, as well as the equivalents thereof.

1. A life-identical virtual reality business platform merged with the IoE, the platform characterized by comprising:
a LOVE-browser (Live Open Virtual Reality Environment Browser) linking an actual real world in which the Internet of Everything (IoE) is operated with a virtual reality world via a user terminal (smart phones, IoE devices, IoE sensors, PCs/tablet PCs, smart TVs, 3D/4D devices, and the like) in an environment in which the Internet of Everything (IoE) is merged, thereby operating vivid virtual reality which is the same as a real life in order to operate the life-identical virtual reality business platform which is the same as the real life;
a real-time interactive virtual reality (VR) server supplying and processing information to the life-identical virtual reality business platform and to a user terminal such that a virtual reality user and an IoE device and the like which need to interact in real time while a user using the Love-browser is using the life-identical virtual reality business platform merged with the IoE smoothly communicate information by interaction;
a VR-AS (Virtual Reality Algorithm Synthesizer) classifying data algorithms transmitted from the real-time interactive virtual reality server and merging an algorithm derived from the IoE device and a virtual reality operational general algorithm, thereby synthesizing and compatibly linking all the algorithms such that when the user uses the platform or experiences virtual reality in the life-identical virtual reality business platform, the user is allowed to use the same in the actual real world;
an IOE-LDRT allowing senses, emotions and feel to be implemented in a wearable device (smart watches, smart bands, IoE sensors attached to human bodies) in response to the IoE device-derived algorithm (algorithm such as space, environments, objects implementing virtual reality) to be reacted by interacting with a biometric bio-activate algorithm for a person which has been generated in the VR-AS (algorithm synthesizer);
a VROM (Virtual Reality Optimization Management) creating and managing an optimal virtual reality environment based on the algorithms transmitted from the IOE-LDRT and the VR-AS in configuring and operating various virtual reality platforms operated in the life-identical virtual reality business platform;
a Live-BPPM (Life identical Virtual Reality-Business Platform Practice Module) allowing the virtual reality environment which is optimally managed in the VROM and the life-identical virtual reality business platform in which various business platforms are operated to be stably executed, and executing the life-identical virtual reality business platform by free information communication with various types of heterogeneous systems and with the user terminal through connection and link with the real world;
a Live-BP (Life Identical Virtual Reality-Business Platform) allowing a user and a business entity using a user terminal executed by the Live-BPPM and operated by the LOVE-browser to be provided with convenience services of daily life in virtual reality which is implemented in the same way as daily life in an environment in which the IoE is merged and operated, and operating various daily life platforms occurring in daily life; and
a BIM (Business Insights Management) inspecting businesses occurring in a business platform operated in the Live-BP, collecting and analyzing ecological operational data, and providing feedback on a managing information to a user terminal and an operator using each platform.

2. The life-identical virtual reality business platform of claim 1, wherein the LOVE-browser comprises:
an MCOS-Scanu (Multi Channel Operating System-Scan unit) integrating and interconverting data transmitted from the user terminal including the IoE device (smart watches, smart bands, IoE sensors and the like), thereby automatically recognizing various user terminals in order to experience and use the life-identical virtual reality business platform, configuring an environment and a channel so as to be linked with the life-identical virtual reality business platform and operated, and enabling virtual reality to be used and communicate information in the corresponding configured virtual reality operation channel;
an ICH (IoE Connect Hub) dividing data having different structural characteristics and transmitted from the MCOS-Scanu into IoE derived data and virtual reality operational general data (data not derived from the IoE device) according a derived object;
an IoE incubator loading and managing only data in which biometric signals such as a psychological state, touch, feel of the user and the business entity are sensed in real time, the data being derived from the IoE device (smart watch, smart band, IoE sensor, etc.) transmitted from the ICH;
an IoE-SB (IoE-Secure Box) for the security of the IoE device-derived data transmitted from the IoE incubator and data derived from an IoE device operated in virtual reality, such as an IoE device and IoE software, in which the IoE is merged and operated, and the security for an IoE device connected in the real world;
a VR-incubator loading and managing the virtual reality operational general data (data not derived from the IoE device) transmitted from the ICH;
an intelligent security system VR-ISB (VR-Interflow Secure Box) in which a virtual reality secure module is installed automatically to enhance the security of the data transmitted from the VR-incubator and another new real-time secure module is generated after a predetermined time period to perform security verification, in order to maintain the stability and integrity in real time of various and vast range of virtual reality operational data for using the Live-BP;
a DCLE (Data Compatible Linkage Editor) eliminating data collision between the virtual reality operational general data transmitted from the VR incubator and the IoE device-derived data transmitted from the IoE incubator so as to smoothly integrate and operate the same;
a VR-DP (VR-Divide Programming) sorting and purifying the data integrated and transmitted from the DCLE so as to be in a data form suitable for operating the Live-BP, and automatically dividing the sorted and purified data into three operational areas;
a Scan Scope sorting and managing scan data such as user scan data and spatial image scan data among the data divided by the VR-DP;
an User Scope sorting and managing user data, business data, and virtual reality operational general data among the data divided by the VR-DP;
a VR-Space Scope sorting and managing spatial image data constituting a virtual reality space and environment among the data divided by the VP-DP and data constituting space, environments and objects configured in the virtual reality space among the IoE device-derived data; and
a RSC (Real-time Stream Connector) merging and interconverting the data transmitted from the Scan Scope, the User Scope, and the VR-Space Scope, thereby automatically connecting the virtual reality operational general data and the IoE device-derived data to a real-time interactive virtual reality server regardless of device, operating system, or program, and transmitting information of the Live-BP to a user terminal in real time through the MCOS-Scanu in the real-time virtual reality server, thereby transmitting information that needs to be fed back by the Live-BP and the user to the ICH.

3. The life-identical virtual reality business platform of claim 2, comprising a HDC (Heterogeneity Data Compatible) enabling heterogeneous data having different sizes and characteristics of data to be combined and compatible in the DCLE (Data Compatible Linkage Editor), thereby enabling the IoE device-derived data to be integrated and compatible.

4. The life-identical virtual reality business platform of claim 2, comprising a homogeneous data divider HDD (Homogeneity Data Divide) dividing data required for the three data operational areas into homogeneous data having the same attributes by the characteristics and associativity of the data in order to operate the Live-BP by classifying unstructured data or a large amount of data, such as the IoE device-derived in the VR-DP.

5. The life-identical virtual reality business platform of claim 1, wherein the LOVE-browser comprises:
a step of merging virtual reality operational general information introduced from the user terminal (information not derived from the IoE device) and the information communication function of the IoE device so as to be operated in various IoE sensors and is connected and linked with any IoE devices regardless of IoE dedicated applications or IoE dedicated software in using the Live-BP which is linked with the real world via the IoE device, thereby using and operating the life-identical virtual reality business platform; and
a step of integrating and interconverting IoE devices operated on a platform of the Live-BP, thereby enabling information communication with the actual real world, and being operated in various user terminals other than a unified device or an on-line site, thereby using the life-identical virtual reality business platform (Live-BP) capable of operating and using actual real situations in which the IoE is operated anytime, anywhere in virtual reality.

6. The life-identical virtual reality business platform of claim 2, comprising
an AST (Autofocus Scanning Tool) supporting and operating the IoE device (smart watches, smart bands, IoE sensors, etc.) or various information communication media with a multi-channel image sensor function in the MCOS-SCanu (Multi Channel Operating System) and providing fast and seamless integration connectivity anytime, anywhere, thereby clearly 3D scanning people, objects, environments and the like from various angles;
a step in which scan information scanned in the ATS and external scan information introduced through the user terminal are automatically connected, thereby allowing users to freely configure a space background and a business environment in the Live-BP; and
a 4DID (4D Interaction Device) in which when information (type, device information) of a wearable (smart watches, smart bands, IoE sensors attached to human bodies, etc.) worn by the user is input in the Mcos-Scanu, a wearable compatible code (WCC) that is compatible with all objects configured in the Live-BP is generated to manage the wearable used by the user, thereby implementing touch and feel of things and environment, emotions during communication and the like while using the Live-BP, wherein a code unique to a wearable is generated and transmitted to the IoE-LDRT in the 4DID such that biometric information generated in a wearable used in the actual real world and biometric information generated in a wearable implemented in the Live-BP may be smoothly communicated, and the WCC (Wearable Compatible Code) is generated such that a wearable corresponding to the generated code is matched with an object to be interacted therewith, and thus, the wearable worn by the user in the real world and is matched with all the things operated in the Live-BP, thereby enabling interaction.

7. The life-identical virtual reality business platform of claim 1, wherein the real-time interaction VR server comprises:
a Real-time Engine determining all the platforms and business information operated in the Live-BP detect situations in real time with a user terminal used by the user in the real world so as to be suitable for a situation in which the Live-BP is used, and processing data such that an operation object of the Live-BP and the user terminal may send and receive data with each other by an real-time interaction;
an IoE Data Furnish Load loading and managing only the IoE-derived data among the data transmitted from the Real-time Engine, and, in order to provide data required for the operation of the Live-BP in real time, supplying the IoE device-derived data according to requirements or processing performance of a data processing supply object (user, business entity, IoE device, IoE sensor, information communication object);
a VR-general Data Furnish Load loading and managing the virtual reality operational general data (data other than the data derived from the IoE device) transmitted from the Real-time Engine, thereby supplying the data required for the operation of the Live-BP in real time;
a DEMM (Data Enlargement Modeling Module) integrating and expanding data in order to prevent the overload of data due to an excess phenomenon of the data transmitted from the IoE Data Furnish Load and the VR-general Data Furnish Load, and in which the modeling of data is achieved such that algorithms of different data are easily merged in the VR-AS (algorithm synthesizer); and
a step of standardizing and stabilizing the structure of data by processing so as to be suitable in integrating and operating a data algorithm derived from the IoE device and a virtual reality operational data algorithm not derived from the IoE device in the DEMM (Data Modeling Module).

8. The life-identical virtual reality business platform of claim 7, wherein the real-time interaction VR server comprises:
a Real-time Reporting sending data introduced from the PIM to the Real-time Engine to provide real-time feedback to the user, the business entity, and the IoE sensor which use the LOVE-browser and the Live-BP, and performing visualization according to needs of the user and the business entity in order to collect and inspect platform information generated in the Live-BP, wherein
the Real-time Reporting includes a step in which information is provided such that various platform information generated in the Live-BP is connected to a business operated in the actual real world and the Live-BP and the actual real world are simultaneously linked to execute the business by interaction, and
a method by which the Real-time Reporting provides information so as to be linked to a platform operated in the real world includes a step of transmitting, among data introduced from the PIM, data that needs immediate feedback to the Live-BP to the Real-time Engine so as to be sent to the IoE Data Furnish Load and the VR-General Data Furnish Load and sending data that need feedback to the user terminal so as to be sent to the Love-browser.

9. The life-identical virtual reality business platform of claim 1, wherein the VR-AS (algorithm synthesizer) comprises:
an ADT (Algorithm Divide Transaction) integrating the IoE device-derived algorithm transmitted from the DEMM and the algorithm not derived from the IoE device (general algorithms of virtual reality operation), creating environments that are classified by relevant areas such that various platforms to be configured in the Live-BP, which is the same as the actual real world, are smoothly configured, and dividing algorithms having similar properties;
an AOP (Algorithm Optimization Process) classifying algorithms according to algorithm characteristics by relevant areas according to platform configurations to generate and synthesize a new algorithm and optimize the algorithm such that various platforms and virtual reality environments to be operated in the Live-BP are smoothly configured based on the algorithms divided and processed in the ADT and introduced therefrom;
a step of classifying into eight algorithm classification areas [(thing, sensor, industry, culture, transportation, energy), (person, human body, health, medical care, bio, etc.), (nature/environment, climate, ecology), (IoE app, IoE software, system, big data, etc.), (virtual reality operational general Information), (Love Browser user, business entity), (spatial image, virtual reality environment configuration), (business platform information, economic information, etc.)] in the AOP;
a step of synthesizing an algorithm corresponding to an area of algorithm divided above so as to be interacted with another algorithm from a different area and utilized in a platform configured in the VROM, thereby implementing a business environment same as actual real world;
an OAL (Optimization Algorithm Linkage) supporting such that the algorithm optimized for Live-BP operation in the AOP implements five senses such touch for environments and things constituting the Live-BP, and sending the optimized algorithm to the VROM in order to configure platforms corresponding to 8 algorithm areas for operating the Live-BP; and
a step of sending the algorithm derived from the IoE device, which needs to react by interaction with a biometric algorithm related to a person in the OAL (Optimization Algorithm Linkage), to the IoE-LDRT for 4D implementation, thereby linking the same with the IoE-LDRT without algorithm errors, wherein
in the step of linking with the IoE-LDRT, a bio-algorithm is included in which the algorithms synthesized and generated in the AOP are converted into a single algorithm in response to a user using the Live-BP, a physical object, a virtual reality environment and the like, and used.

10. The life-identical virtual reality business platform of claim 9, comprising
an Active Algorithm including a step of combining each algorithm that are embedded in the eight algorithm areas divided by the algorithms introduced from the ADT into a single form and synthesizing and generating an algorithm in order to configure the Live-BP in the optimization processing step of generating and synthesizing an algorithm in the AOP, and generated during synthesizing an initial algorithm which is combining algorithms into a single shape in the step of synthesizing and generating an algorithm, wherein
the activate algorithm is an algorithm in which heterogeneous algorithms according to similar characteristics and association with each other of the algorithms divided into eight algorithm areas in the AOP form an algorithm DNA by themselves, thereby having new characteristics, and includes a step which becomes a source for synthesizing and merging the IoE device-derived algorithm.

11-12. (canceled)

13. The life-identical virtual reality business platform of claim 1, wherein the IoE-LDRT comprises a step of implementing touch, feel and emotions of a person which are generated by interaction between a biometric algorithm of a user and a third algorithm related thereto (IoE-derived algorithm) in an environment merged with the IoE, thereby implementing the same in a wearable (smart watches, smart bands, IoE sensors attached to human bodies) worn by the user who uses the Live-BP in an actual real world such that real-time biometric action takes place, wherein a method of implementing touch, feel, and emotions in the wearable used by the user and operated in the actual real world above includes a step of matching the user who uses the Live-BP with an interaction object in the 4DID which is a component of the LOVE-browser so as to experience feel of all actions of the user in the Live-BP in the actual real world via the wearable.

14. The life-identical virtual reality business platform of claim 1, wherein the VROM comprises:
a step of configuring a variety of daily life-type platforms and various business platforms which are to be operated in the Live-BP so as to be optimized for a user, such as user's environment, purpose of use, and business type, and allowing an IoE device to be operated in the configured platforms, thereby linking the algorithms introduced from the OAL and the IoE-LDRT with the actual real world to be operated;
a step of performing optimization such that users, corporations, business entities, IoE devices, IoE objects and the like that operate and use the various business platforms configured above have the same life, businesses, and the like as in daily life in the actual real world;
a VR-USD (Virtual Reality-Use Scope Distinction) classifying, as a base step of configuring various platforms which are to be operated and used in Live-BP in performing the optimization processing, six platform configuration areas [(Platform area—for industry, for business), (IoE operation area), (Business model supply/use area-education, culture, game, consulting, service, distribution, etc.), (Various events areas such as travel, exhibition, sightseeing, group, etc.), (Experience, SNS, hobby, communication area), (Shopping, purchase, agency, service area)] to allow a user and an operator to configure a platform so as to meet the purpose and usage of use/operation;
a VR-BPC (Virtual Reality-Business Platform Composition) allowing a virtual reality platform to be freely set and configured for the six platform configuration areas classified in the VR-USD by optimizing for the application purpose of a user who uses the Live-BP, and allowing the same to be compatible with all the platforms operated in the actual real world, thereby configuring various life-identical platforms closely related to daily life of the actual real world so as to be used in the actual real world and in the Live-BP, simultaneously;
a step in which the platforms configured above conform to platforms operated in the real world and the standardization of the Live-BP is established due to popularization of virtual reality platforms;
a Live-Bio (Life identical Virtual Reality-Business implementation Optimization) creating a virtual reality environment optimized for the environment of a user and an operator and creating life and business platform environments same as in the actual real world, thereby providing optimized life-identical platforms configured in the VR-BPC; and
a VR-archive, which is a platform information management space, managing and loading various platform information and virtual reality data configured in the VR-BPC, thereby allowing a user, anytime and anywhere via a user terminal in which the LOVE-browser is operated, to store, confirm, and delete platform use information such as user's personal information and platform use history according to the requirements of a Live-BP user.

15. The life-identical virtual reality business platform of claim 14, comprising
an IAI (IoE Algorithm Interpretation) combining and interpreting algorithms to set and generate areas suitable for configuring a platform in the VR-USD, and classifying the areas into six platform configuration areas; and
a step in which the IAI automatically finds the same information communication algorithm as that of a user terminal in which the Love-browser is operated, and classifying the algorithm to enable information communication in a platform configured in the 6 platform configuration areas.

16-17. (canceled)

18. The life-identical virtual reality business platform of claim 1, further comprising a step of securing compatibility for stable connection between an actual real world and a virtual reality world connected via a user terminal in the Live-BPPM, and integrating and operating IOE operations, identification systems, IoE devices, and IoE sensor, thereby operating and using the Live-BP in operating a platform configured in the VROM.

19. The life-identical virtual reality business platform of claim 1, wherein the Live-BP comprises:
in an environment merged with the IoE, a step in which a user using a user terminal in which the LOVE-browser is operated freely participates in the Live-BP so that a user and a business, a business and a business, a user and a user, a user/business and an IoE device, and IoE device and an IoE device share by information communication by interaction, and the public use various virtual reality platforms due to voluntary participation of the public in the Live-BP;
a step of supporting the distribution of platforms such that daily convenience services and business models of the public operated in the Live-BP are operated smoothly;
a step of integrating business models operated due to the platform distribution in the Live-BP and distribution channels inside the business models to provide various shopping platform environments, thereby providing optimized information for a consumer's situation in a real space in which the real life of a consumer takes place to induce purchase and distribution;
a step in which a use entity (users, businesses, IoE devices, IoE sensors) of various platforms which are distributed in the Live-BP interacts with a use entity (users, businesses, IoE devices, IoE sensors) of a platform operated in a real world, so that businesses and every daily life are operated in the same manner as reality;
a VRFP (Virtual Reality Finance Platform) allowing financial transaction services which are operated in an actual real world to be linked to various platforms operated in the Live-BP and operated;
a step of communicating information with IoE devices and IoE sensors implemented in the Live-BP, so that when an IoE device is used in the Live-BP, the IoE device is also connected and linked in an actual real life to connect and link the Live-BP and the real actual world through communication with the IoE device via a user terminal in which the LOVE-browser is operated, thereby allowing living the same life;
due to the IoE operation environment in the above in which a user and a physical space of the Live-BP interact through communication with an IoE device, in using and operating each platform operated in the Live-BP by being configured for six virtual reality platform configuration areas classified in the VR-USD, a step of implementing an actual real world workplace or an environment in the above platform, thereby executing a life-identical factory in which virtual reality and a smart factory are merged and which is capable of controlling the environment via an IoE device operated in the Live-BP without having to go to a site;
a business library in which all the information from using a platform and living and experiencing daily life which take place in the Live-BP transmit all the information about the needs and operations of a user and an IoE object to the LOVE-browser, thereby allowing real-time feedback with the user via a user terminal; and
a VR-IDM (VR-IoE Device Manager), a virtual reality IoE device management system that is capable of establishing a full-cycle relationship system between IoE devices and IoE sensors in order to effectively manage the IoE devices and the IoE sensors used by connecting and linking the Live-BP and a real world.

20. The life-identical virtual reality business platform of claim 19, wherein the business library comprises:
an information communication step connecting and linking a business entity (user, IoE object, platform operator) running in the Live-BP with a user terminal via the LOVE-browser, thereby allowing the same to communicate with an actual business entity in an actual real world; and
a circular information transmission step in which an information transmission method in the business library is performed by transmitting behavior motions of a user, a business entity and an IoE object taking place in the Live-BP and responses of an information object operated in the Live-BP by an information execution command via a user terminal by a real-time response and an information command caused by the interaction with a real-world information object, and the IoE object delivers an execution result (information) of the Live-BP to the LOVE-browser in real time by an automatic information execution command system of the IoE object and a command and behavior motions of the user terminal.

21. (canceled)

22. The life-identical virtual reality business platform of claim 19, wherein the VRFP (Virtual Reality Finance Platform) comprises:
a step of supporting financial transactions and electronic payment services performed on a platform operated in the Live-BP, thereby performing financial operations using a user terminal in an environment in which virtual reality and the IoE is merged; and
a VR-security token, a security authentication step that enables users using the Live-BP via the LOVE-browser to perform financial transactions (remittance, payment, settlement, investment, asset management, loan, credit card, securities business, transfer, ATM) through the VRFP anytime and anywhere by a simultaneous linkage between the Live-BP and an actual real world.

23. The life-identical virtual reality business platform of claim 22, wherein the VR-security token comprises:
during a financial transaction through the VRFP by connecting an linking the Live-BP which is an environment in which the IoE is merged and an actual real world, a step of generating a security token by its own lightweight cryptographic algorithm processing to perform authentication of a user authentication object (IoE devices, financial services);
a step of Integrating IoE components such as sensors, devices, communications, networks, and operation services that are operated on a financial business platform which is operated in the Live-BP to determine whether the VR-security token information generated at the time of a financial transaction is matched with user authentication authenticated in the LOVE-browser or IoE device authentication at the same time in order to achieve the financial transaction;
a FAM (Finance Account Module) transmitting payment information authenticated in the VR-security token to the user terminal through the LOVE-browser; and
a step of connecting and linking the FAM with a user terminal in which the Love-browser is operated in a process taking place through the financial business VRFP performed in the Live-BP such that financial transactions taking place in an actual real world are connected and operated in the Live-BP.

24. The life-identical virtual reality business platform of claim 1, wherein the BIM (Business Insights Management) comprises:
a BEA (Business Ecosystem analysis) classifying platform information according to the form and operation thereof taking place in the Live-BP to analyze a business ecosystem, and a BPA (Business Practice Analysis) analyzing the execution and operation of platforms of the Live-BP and actual real world according to the classification; and
a PCM (Platform Communication Module) integrating information of the BEA and the BPA to transmit platform information to entities and users of a platform who use the Live-BP for guidelines on the operation and use of the platform in an organic connection and linkage.

25. The life-identical virtual reality business platform of claim 24, comprising:
a PBM (Platform Biolysis Module) having morphological characteristics of data generated in the Live-BP, and classifying the classifications according to the form and operation of the platform information in the PIM into ecological data and execution analytical data;
a step of sending the ecological data classified in the PBM (Platform Ecological module) to the BEA, and sending the platform execution data to the BPA;
in analyzing business ecosystems in the BEA (Business Ecosystem Analysis), a BBA (Business Biology Algorithm) performing sentiment extraction between a user and a business and ecological analysis of the correlation between a business and a business, and performing relationship analysis between the execution of business and the sentiment of a business entity and business ecology; and
by the sentiment analysis of a business entity in the BBA, a step of intuitively understanding reactions of users and consumers who are doing business in the Live-BP to reflect the same on actual real world businesses, and providing business ecology information to operators and users of platforms of the Live-BP, wherein
the BPA (Business Execution Analysis) includes a step of analyzing business execution data executed in the Live-BP and providing optimized business execution information to users, and
the PCM (Platform Information Delivery Module) includes a step of sending data introduced from the BEA and the BPA to Real-time Reporting, which is a component of the real-time interaction VR server, and transmitting the same via a user terminal in which the LOVE-browser is operated to users of the actual real world and users and business entities of the Live-BP.
